(19) United States
(12) Patent Application Publication
(10) Pub. No.: US 2011/0314506 A1
(43) Pub. Date: Dec. 22, 2011

(54) Point to multi-point wireless video delivery

(75) Inventors: Peyush Agarwal, Milpitas, CA (US); Yasantha N. Rajakarunanayake, San Ramon, CA (US); Alexander G. MacInnis, Los Altos, CA (US); James D. Bennett, Hroznetin (CZ); William S. Bunch, Menlo Park, CA (US); James F. Dougherty, III, Morgan Hill, CA (US)

(73) Assignee: BROADCOM CORPORATION, IRVINE, CA (US)

(21) Appl. No.: 13/220,571

(22) Filed: Aug. 29, 2011

Related U.S. Application Data
(63) Continuation-in-part of application No. 12/327,041, filed on Dec. 3, 2008.
(60) Provisional application No. 61/491,838, filed on May 31, 2011.
(60) Provisional application No. 61/086,877, filed on Aug. 7, 2008.

(51) Int. Cl. H04N 7/16

(52) U.S. Cl. 725/62

(57) ABSTRACT

Point to multi-point wireless video delivery. Among a group of receiver wireless communication devices (RXs), one is designated (e.g., as acknowledgment (ACK) leader). Media delivery operational parameters are selected based on the designated RX or based on all or a subset of the RXs. For simultaneous media delivery to multiple RXs, characteristics associated with the designated RX [or all, or a subset or RXs] govern the manner by which communications are made. Different respective RXs may be designated to serve in this role at different times. Wireless delivery of media (e.g., video signaling, audio signaling, etc.) to a group of RXs is effectuated in accordance with modified multicast signaling with a designated leader (e.g., ACK leader). Among a group of devices, a least successful receiving device that still receives media at an acceptable level may be chosen as the designated leader (e.g., ACK leader).

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional Patent Application which is hereby incorporated herein by reference in its entirety and made part of the present U.S. Utility patent application for all purposes:

1. U.S. Provisional Patent Application Ser. No. 61/491,838, entitled “Media communications and signaling within wireless communication systems,” (Attorney Docket No. BP22744), filed May 31, 2011, pending.

### Continuation-In-Part (CIP) Priority Claim, 35 U.S.C. §120

The present U.S. Utility patent application claims priority pursuant to 35 U.S.C. §120, as a continuation-in-part (CIP), to the following U.S. Utility patent application which is hereby incorporated herein by reference in its entirety and made part of the present U.S. Utility patent application for all purposes:

1. U.S. Utility patent application Ser. No. 12/327,041, entitled “Multicast digital video lost packet recovery,” (Attorney Docket No. BP7202), filed Dec. 3, 2008, pending, which claims priority pursuant to 35 U.S.C. §119(e) to the following U.S. Provisional Patent Application which is hereby incorporated herein by reference in its entirety and made part of the present U.S. Utility patent application for all purposes:

1.1. U.S. Provisional Patent Application Ser. No. 61/086,877, entitled “Multicast digital video lost packet recovery,” (Attorney Docket No. BP7202), filed Aug. 7, 2008, now expired.

### Incorporation by Reference

The following standards/draft standards are hereby incorporated herein by reference in their entirety and are made part of the present U.S. Utility patent application for all purposes:

1. “WD3: Working Draft 3 of High-Efficiency Video Coding, Joint Collaborative Team on Video Coding (JCT-VC),” of ITU-T SG16 WP3 and ISO/IEC JTC1/SC29/WG11, Thomas Wiegand, et al., 5^{th} Meeting: Geneva, CH, 16-23 Mar., 2011, Document: JCTVC-E603, 215 pages.

2. International Telecommunication Union, ITU-T, TELECOMMUNICATION STANDARDIZATION SECTOR OF ITU, H.264 (March/2010), SERIES H: AUDIOVISUAL AND MULTIMEDIA SYSTEMS, Infrastructure of audiovisual services—Coding of moving video, Advanced video coding for generic audiovisual services, Recommendation ITU-T H.264, also alternatively referred to as International Telecomm ISO/IEC 14496-10—MPEG-4 Part 10, AVC (Advanced Video Coding), H.264/MPEG-4 Part 10 or AVC (Advanced Video Coding), ITU H.264/MPEG4-AVC, or equivalent.

### Incorporation by Reference

The following IEEE standards/draft IEEE standards are hereby incorporated herein by reference in their entirety and are made part of the present U.S. Utility patent application for all purposes:

1. IEEE Std 802.11™—2007, “IEEE Standard for Information technology—Telecommunications and information exchange between systems—Local and metropolitan area networks—Specific requirements; Part 11: Wireless LAN Medium Access Control (MAC) and Physical Layer (PHY) Specifications,” IEEE Computer Society, IEEE Std 802.11™—2007, (Revision of IEEE Std 802.11-1999), 1233 pages.

2. IEEE Std 802.11n™—2009, “IEEE Standard for Information technology—Telecommunications and information exchange between systems—Local and metropolitan area networks—Specific requirements; Part 11: Wireless LAN Medium Access Control (MAC) and Physical Layer (PHY) Specifications; Amendment 5: Enhancements for Higher Throughput,” IEEE Computer Society, IEEE Std 802.11n™—2009, (Amendment to IEEE Std 802.11™—2007 as amended by IEEE Std 802.11k™—2008, IEEE Std 802.11r™—2008, IEEE Std 802.11y™—2008, and IEEE Std 802.11r™—2009), 536 pages.

3. IEEE P802.11ac™/D1.1, August 2011, “Draft STANDARD for Information Technology—Telecommunications and information exchange between systems—Local and metropolitan area networks—Specific requirements, Part 11: Wireless LAN Medium Access Control (MAC) and Physical Layer (PHY) specifications, Amendment 5: Enhancements for Very High Throughput for Operation in Bands below 6 GHz,” Prepared by the 802.11 Working Group of the 802 Committee, 297 total pages (pp. i-xxiii, 1-274).

### BACKGROUND OF THE INVENTION

1. Technical Field of the Invention

The invention relates generally to communication systems; and, more particularly, it relates to effectuating point to multi point wireless communications including effectuating video communications therein.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11x, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to the antenna and includes a low noise amplifier, one or more intermediate frequency stages, a filtering stage, and a data recovery stage. The low noise amplifier receives inbound RF signals via the antenna and amplifies them. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier (PA). The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

Typically, the transmitter will include one antenna for transmitting the RF signals, which are received by a single antenna, or multiple antennae (alternatively, antennas), of a receiver. When the receiver includes two or more antennae, the receiver will select one of them to receive the incoming RF signals. In this instance, the wireless communication between the transmitter and receiver is a single-output-single-input (SISO) communication, even if the receiver includes multiple antennae that are used as diversity antennae (i.e., selecting one of them to receive the incoming RF signals). For SISO wireless communications, a transceiver includes one transmitter and one receiver. Currently, most wireless local area networks (WLAN) that are IEEE 802.11, 802.11a, 802.11b, or 802.11g employ SISO wireless communications.

Other types of wireless communications include single-input-multiple-output (SIMO), multiple-input-single-output (MISO), and multiple-input-multiple-output (MIMO). In a SIMO wireless communication, a single transmitter processes data into radio frequency signals that are transmitted to a receiver. The receiver includes two or more antennae and two or more receiver paths. Each of the antennae receives the RF signals and provides them to a corresponding receiver path (e.g., LNA, down conversion module, filters, and ADCs). Each of the receiver paths processes the received RF signals to produce digital signals, which are combined and then processed to recapture the transmitted data.

For a multiple-input-single-output (MISO) wireless communication, the transmitter includes two or more transmission paths (e.g., digital to analog converter, filters, up-conversion module, and a power amplifier) that each converts a corresponding portion of baseband signals into RF signals, which are transmitted via corresponding antennae to a receiver. The receiver includes a single receiver path that receives the multiple RF signals from the transmitter. In this instance, the receiver uses beam forming to combine the multiple RF signals into one signal for processing.

For a multiple-input-multiple-output (MIMO) wireless communication, the transmitter and receiver each include multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The recaptured streams of data are combined and subsequently processed to recover the original data.

With the various types of wireless communications (e.g., SISO, MISO, SIMO, and MIMO), and particularly within communication devices that may employ multiple communication paths therein, the present art does not provide an adequate solution by which various communications maybe performed and operated in a communication device without deleterious affecting one another.

In the context of wireless communications and particularly the transmission and receipt of signals therein that include media content (e.g., video, audio, etc.), certain considerations should be made that are not necessary within non-media related signaling. For example, certain non-media related signals do not suffer significant degradation of performance from latency, delay, etc. Often times, such media related content communications are relatively more time critical than non-media related content communications. Particularly in the context of wireless communications, the present art does not provide an adequate means by which media related content communications may be effectuated in a robust, reliable, and perceptually acceptable manner.

### BRIEF DESCRIPTION OF THE SEVERAL VIEWS OF THE DRAWINGS

FIG. 1 and FIG. 2 are diagrams illustrating various embodiments of communication systems.

FIG. 3 is a diagram illustrating an alternative embodiment of a wireless communication system.

FIG. 4 is a diagram illustrating an embodiment of a wireless communication device.

FIG. 5 is a diagram illustrating an alternative embodiment of a wireless communication device.

FIG. 6 is a diagram illustrating an embodiment of supporting communications from a transmitter wireless communication device to a number of receiver wireless communication devices based on a designated receiver wireless communication device.

FIG. 7 is a diagram illustrating an embodiment of supporting communications from a transmitter wireless communication device to a number of receiver wireless communication devices in accordance with best effort and particularly with respect to tailoring, adapting, and/or adjusting operational parameters with respect to a selected or designated one of the receiver wireless communication devices operate.

FIG. 8 is a diagram illustrating an embodiment of supporting communications from a transmitter wireless communication device to a number of receiver wireless communication devices based on bi-directional communications (e.g., management, adaptation, control, acknowledgements (ACKs), etc.) with a designated one of the receiver wireless communication devices.

FIG. 9 is a diagram illustrating an embodiment of supporting communications from a transmitter wireless communication device to a number of receiver wireless communication devices including adaptive selection of different receiver wireless communication devices for governing operation there among.

FIG. 10 is a diagram illustrating an embodiment of feedback from a number of receiver wireless communication devices to a transmitter wireless communication device.

FIG. 11 is a diagram illustrating an embodiment of grouping of receiver wireless communication devices into respective groups and supporting of communications selectively with each respective group.

FIG. 12 is a diagram illustrating an embodiment of an aircraft application adapted for supporting communications from a transmitter wireless communication device to a number of receiver wireless communication devices.

FIG. 13 is a diagram illustrating an embodiment of grouping of receiver wireless communication devices into respective groups and supporting communications thereto with respectively different operational parameter(s).

FIG. 14 is a diagram illustrating an embodiment depicting relationship between bit rate and range in accordance with supporting communications from a transmitter wireless communication device to a number of receiver wireless communication devices.

FIG. 15A, FIG. 15B, FIG. 16A, FIG. 16B, FIG. 17A, and FIG. 17B illustrate various embodiment of methods as may be performed in accordance with operation of various devices such as various wireless communication devices.

### DETAILED DESCRIPTION OF THE INVENTION

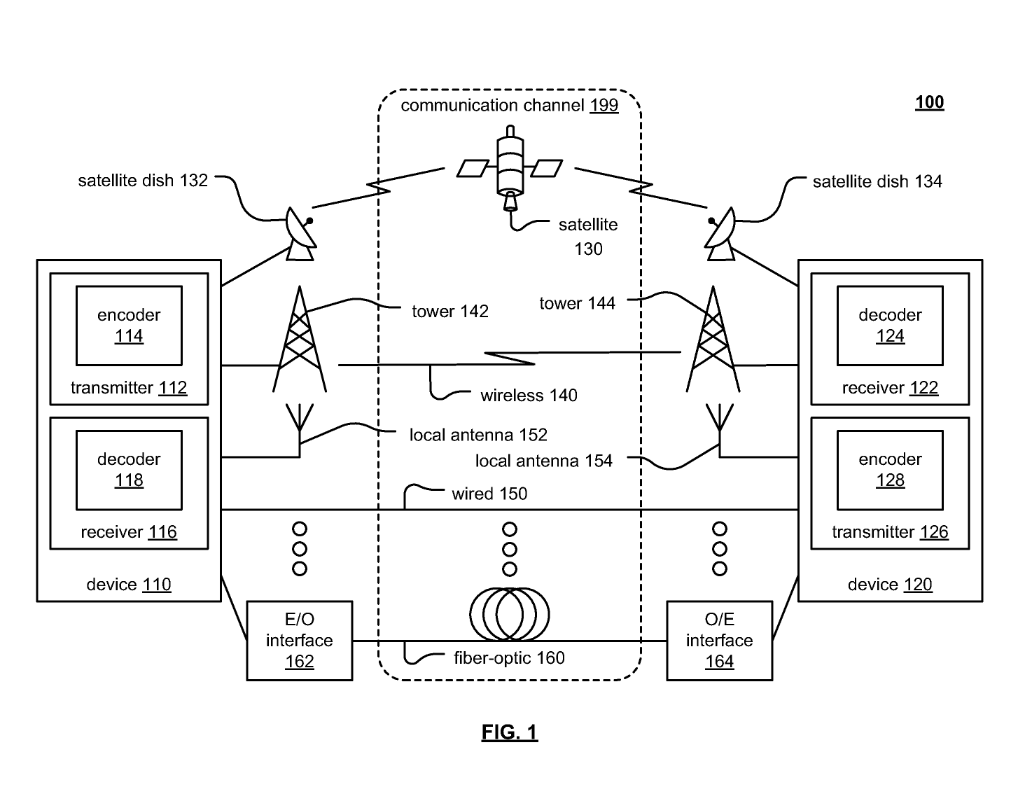

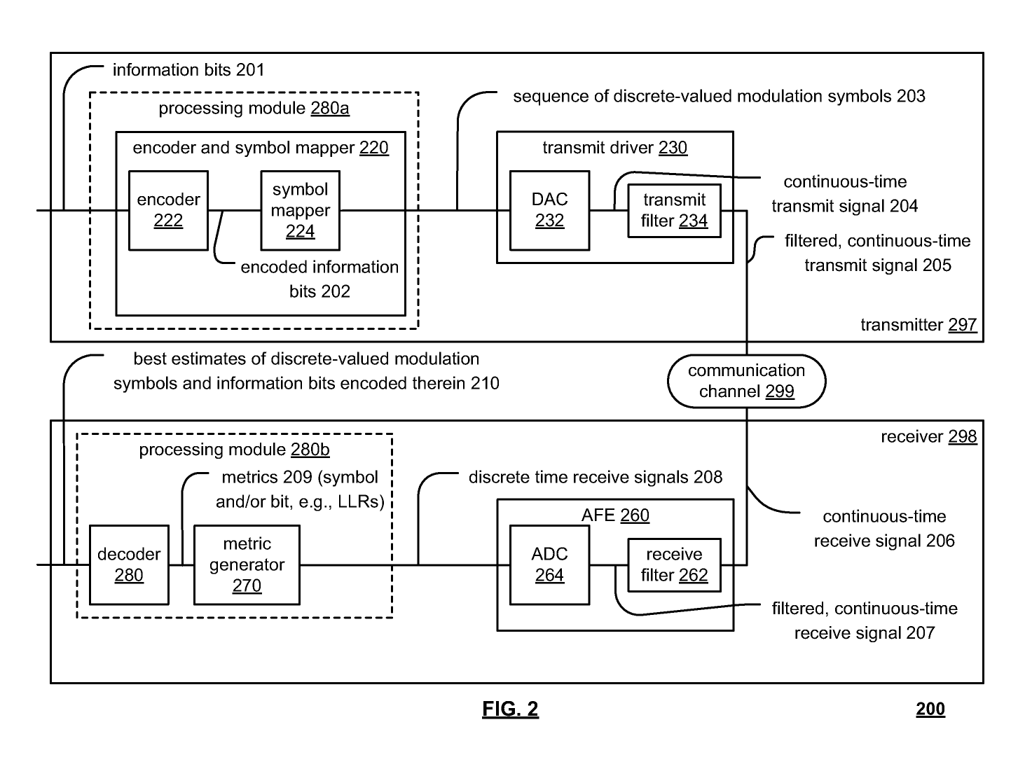

Within communication systems, signals are transmitted between various communication devices therein. The goal of digital communications systems is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

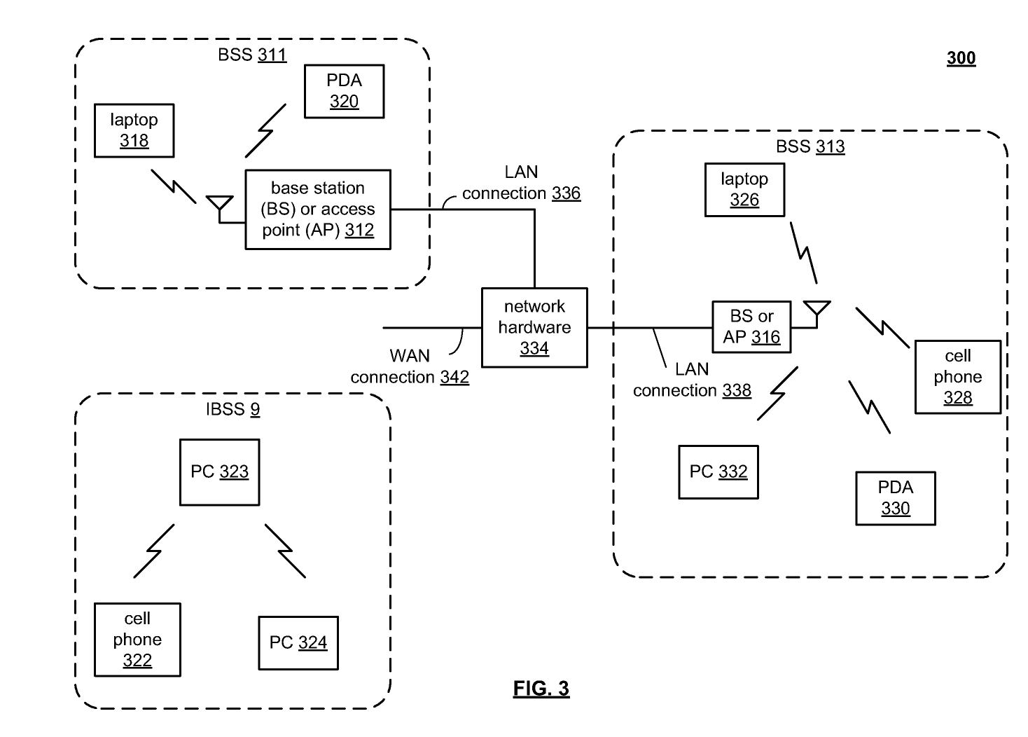

FIG. 1 and FIG. 2 are diagrams illustrating various embodiments of communication systems, 100, and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299).

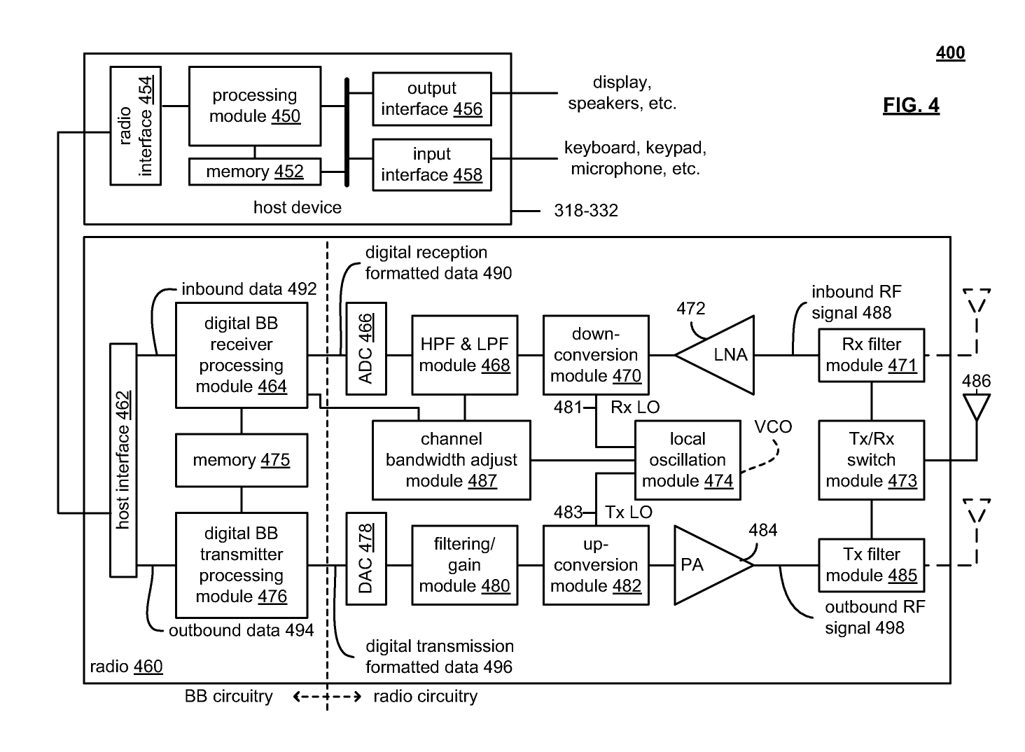

FIG. 3 is a diagram illustrating an embodiment of a wireless communication system 300. The wireless communication system 300 includes a plurality of base stations and/or access points 312, 316, a plurality of wireless communication devices 318-332 and a network hardware component 334. Note that the network hardware 334, which may be a router, switch, bridge, modem, system controller, etc., provides a wide area network connection 342 for the communication system 300. Further note that the wireless communication devices 318-332 may be laptop host computers 318 and 326, personal digital assistant hosts 320 and 330, personal computer hosts 324 and 332 and/or cellular telephone hosts 322 and 328.

Wireless communication devices 322, 323, and 324 are located within an independent basic service set (IBSS) area and communicate directly (i.e., point to point). In this configuration, these devices 322, 323, and 324 may only communicate with each other. To communicate with other wireless communication devices within the system 300 or to communicate outside of the system 300, the devices 322, 323, and/or 324 need to affiliate with one of the base stations or access points 312 or 316.

The base stations or access points 312, 316 are located within basic service set (BSS) areas 311 and 313, respectively, and are operably coupled to the network hardware 334 via local area network connections 336, 338. Such a connection provides the base station or access point 312-316 with connectivity to other devices within the system 300 and provides connectivity to other networks via the WAN connection 342. To communicate with the wireless communication devices within its BSS 311 or 313, each of the base stations or access points 312-116 has an associated antenna or antenna array. For instance, base station or access point 312 wirelessly communicates with wireless communication devices 318 and 320 while base station or access point 316 wirelessly communicates with wireless communication devices 326-332. Typically, the wireless communication devices register with a particular base station or access point 312, 316 to receive services from the communication system 300.

Typically, base stations are used for cellular telephone systems (e.g., advanced mobile phone services (AMPS), digital AMPS, global system for mobile communications (GSM), code division multiple access (CDMA), local multi-point distribution systems (LMDS), multi-channel-multi-point distribution systems (MMDS), Enhanced Data rates for GSM Evolution (EDGE), General Packet Radio Service (GPRS), high-speed downlink packet access (HSDPA), high-speed uplink packet access (HSUPA and/or variations thereof) and like-type systems, while access points are used for in-home or in-building wireless networks (e.g., IEEE 802.11, Bluetooth, ZigBee, any other type of radio frequency based network protocol and/or variations thereof). Regardless of the particular type of communication system, each wireless communication device includes a built-in radio and/or is coupled to a radio. It is also noted that the various operations and functionality as presented herein may be generally applied to any type of wireless communication system operating in accordance with any one or more communication standards, protocols, recommended practices, and/or combinations thereof. For example, certain communication systems provide for simultaneous operation of two or more communication standards, protocols, recommended practices, etc. Generally speaking, the wireless communications as described herein may be implemented in accordance with any one or more communication standards, protocols, recommended practices, etc.

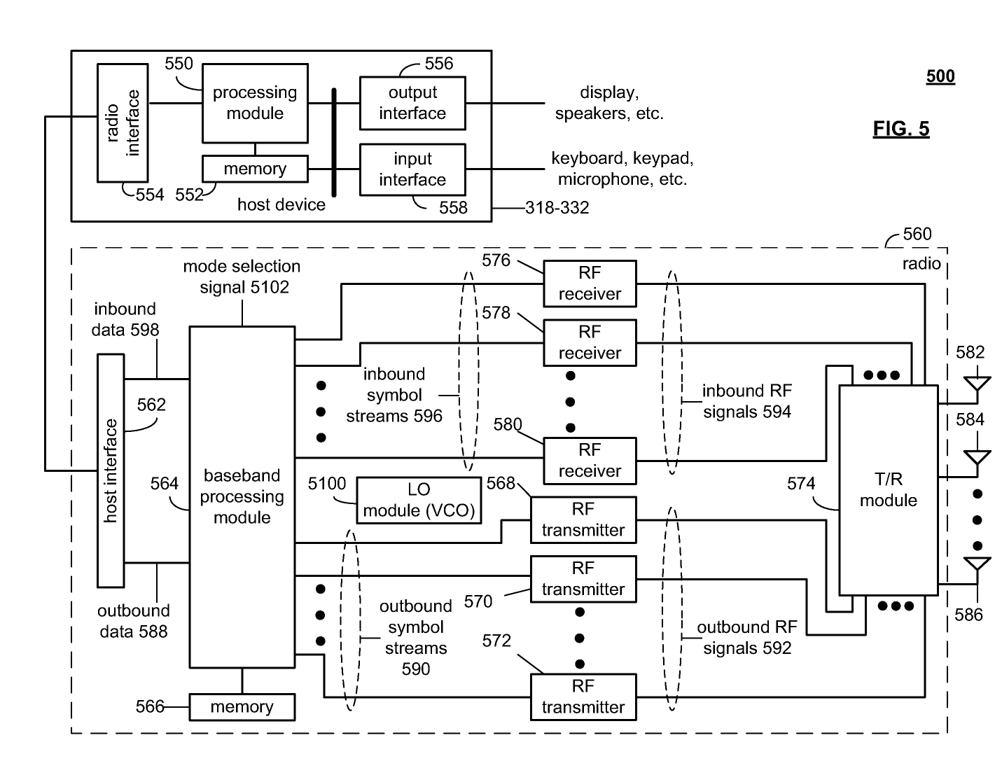

FIG. 4 is a diagram illustrating an embodiment 300 of a wireless communication device that includes the host device 318-332 and an associated radio 460. For cellular telephone hosts, the radio 460 is a built-in component. For personal digital assistants hosts, laptop hosts, and/or personal computer hosts, the radio 460 may be built-in or an externally coupled component.

As illustrated, the host device 318-332 includes a processing module 450, memory 452, a radio interface 454, an input interface 458, and an output interface 456. The processing module 450 and memory 452 execute the corresponding instructions that are typically done by the host device. For example, for a cellular telephone host device, the processing module 450 performs the corresponding communication functions in accordance with a particular cellular telephone standard.

The radio interface 454 allows data to be received from and sent to the radio 460. For data received from the radio 460 (e.g., inbound data), the radio interface 454 provides the data to the processing module 450 for further processing and/or routing to the output interface 456. The output interface 456 provides connectivity to an output display device such as a display, monitor, speakers, etc., such that the received data may be displayed. The radio interface 454 also provides data from the processing module 450 to the radio 460. The processing module 450 may receive the outbound data from an input device such as a keyboard, keypad, microphone, etc., via the input interface 458 or generate the data itself. For data received via the input interface 458, the processing module 450 may perform a corresponding host function on the data and/or route it to the radio 460 via the radio interface 454.

Radio 460 includes a host interface 462, digital receiver processing module 464, an analog-to-digital converter 466, a high pass and low pass filter module 468, an IF mixing down conversion stage 470, a receiver filter 471, a low noise amplifier 472, a transmitter/receiver switch 473, a local oscillation module 474 (which may be implemented, at least in part, using a voltage controlled oscillator (VCO)), memory 475, a digital transmitter processing module 476, a digital-to-analog converter 478, a filtering/gain module 480, an IF mixing up conversion stage 482, a power amplifier 484, a transmitter filter module 485, a channel bandwidth adjust module 487, and an antenna 486. The antenna 486 may be a single antenna that is shared by the transmit and receive paths as regulated by the Tx/Rx switch 473, or may include separate antennas for the transmit path and receive path. The antenna implementation will depend on the particular standard to which the wireless communication device is compliant.

The digital receiver processing module 464 and the digital transmitter processing module 476, in combination with operational instructions stored in memory 475, execute digital receiver functions and digital transmitter functions, respectively. The digital receiver functions include, but are not limited to, digital intermediate frequency to baseband conversion, demodulation, constellation demapping, decoding, and/or descrambling. The digital transmitter functions include, but are not limited to, scrambling, encoding, constellation mapping, modulation, and/or digital baseband to IF conversion. The digital receiver and transmitter processing modules 464 and 476 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 475 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 464 and/or 476 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 460 receives outbound data 494 from the host device via the host interface 462. The host interface 462 routes the outbound data 494 to the digital transmitter processing module 476, which processes the outbound data 494 in accordance with a particular wireless communication standard (e.g., IEEE 802.11, Bluetooth, ZigBee, WiMAX (Worldwide Interoperability for Microwave Access), any other type of radio frequency based network protocol and/or variations thereof etc.) to produce outbound baseband signals 496. The outbound baseband signals 496 will be digital base-band signals (e.g., have a zero IF) or digital low IF signals, where the low IF typically will be in the frequency range of one hundred kHz (kilo-Hertz) to a few MHz (Mega-Hertz).

The digital-to-analog converter 478 converts the outbound baseband signals 496 from the digital domain to the analog domain. The filtering/gain module 480 filters and/or adjusts the gain of the analog signals prior to providing it to the IF mixing stage 482. The IF mixing stage 482 converts the analog baseband or low IF signals into RF signals based on a transmitter local oscillation 483 provided by local oscillation module 474. The power amplifier 484 amplifies the RF signals to produce outbound RF signals 498, which are filtered by the transmitter filter module 485. The antenna 486 transmits the outbound RF signals 498 to a targeted device such as a base station, an access point and/or another wireless communication device.

The radio 460 also receives inbound RF signals 488 via the antenna 486, which were transmitted by a base station, an access point, or another wireless communication device. The antenna 486 provides the inbound RF signals 488 to the receiver filter module 471 via the Tx/Rx switch 473, where the Rx filter 471 bandpass filters the inbound RF signals 488. The Rx filter 471 provides the filtered RF signals to low noise amplifier 472, which amplifies the signals 488 to produce an amplified inbound RF signals. The low noise amplifier 472 provides the amplified inbound RF signals to the IF mixing module 470, which directly converts the amplified inbound RF signals into an inbound low IF signals or baseband signals based on a receiver local oscillation 481 provided by local oscillation module 474. The down conversion module 470 provides the inbound low IF signals or baseband signals to the filtering/gain module 468. The high pass and low pass filter module 468 filters, based on settings provided by the channel bandwidth adjust module 487, the inbound low IF signals or the inbound baseband signals to produce filtered inbound signals.

The analog-to-digital converter 466 converts the filtered inbound signals from the analog domain to the digital domain to produce inbound baseband signals 490, where the inbound baseband signals 490 will be digital base-band signals or digital low IF signals, where the low IF typically will be in the frequency range of one hundred kHz to a few MHz. The digital receiver processing module 464, based on settings provided by the channel bandwidth adjust module 487, decodes, descrambles, demaps, and/or demodulates the inbound baseband signals 490 to recapture inbound data 492 in accordance with the particular wireless communication standard being implemented by radio 460. The host interface 462 provides the recaptured inbound data 492 to the host device 318-332 via the radio interface 454.

As one of average skill in the art will appreciate, the wireless communication device of the embodiment 400 of FIG. 4 may be implemented using one or more integrated circuits. For example, the host device may be implemented on one integrated circuit, the digital receiver processing module 464, the digital transmitter processing module 476 and memory 475 may be implemented on a second integrated circuit, and the remaining components of the radio 460, less the antenna 486, may be implemented on a third integrated circuit. As an alternate example, the radio 460 may be implemented on a single integrated circuit. As yet another example, the processing module 450 of the host device and the digital receiver and transmitter processing modules 464 and 476 may be a common processing device implemented on a single integrated circuit. Further, the memory 452 and memory 475 may be implemented on a single integrated circuit and/or on the same integrated circuit as the common processing modules of processing module 450 and the digital receiver and transmitter processing module 464 and 476.

Any of the various embodiments of communication device that may be implemented within various communication systems can incorporate functionality to perform communication via more than one standard, protocol, or other predetermined means of communication. For example, a single communication device, designed in accordance with certain aspects of the invention, can include functionality to perform communication in accordance with a first protocol, a second protocol, and/or a third protocol, and so on. These various protocols may be WiMAX (Worldwide Interoperability for Microwave Access) protocol, a protocol that complies with a wireless local area network (WLAN/WiFi) (e.g., one of the IEEE (Institute of Electrical and Electronics Engineer) 802.11 protocols such as 802.11a, 802.11b, 802.11g, 802.11n, 802.11ac, etc.), a Bluetooth protocol, or any other predetermined means by which wireless communication may be effectuated.

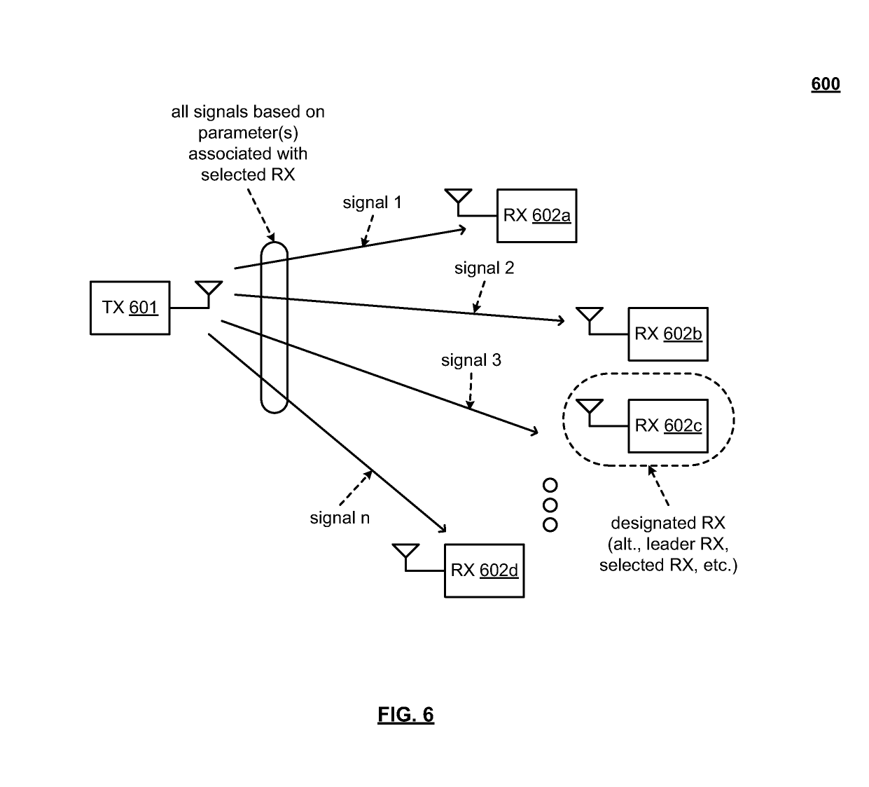

FIG. 5 is a diagram illustrating an alternative embodiment of a wireless communication device that includes the host device 318-332 and an associated at least one radio 560. For cellular telephone hosts, the radio 560 is a built-in component. For personal digital assistants hosts, laptop hosts, and/or personal computer hosts, the radio 560 may be built-in or an externally coupled component. For access points or base stations, the components are typically housed in a single structure.

As illustrated, the host device 318-332 includes a processing module 550, memory 552, radio interface 554, input interface 558 and output interface 556. The processing module 550 and memory 552 execute the corresponding instructions that are typically done by the host device. For example, for a cellular telephone host device, the processing module 550 performs the corresponding communication functions in accordance with a particular cellular telephone standard.

The radio interface 554 allows data to be received from and sent to the radio 560. For data received from the radio 560 (e.g., inbound data), the radio interface 554 provides the data to the processing module 550 for further processing and/or routing to the output interface 556. The output interface 556 provides connectivity to an output display device such as a display, monitor, speakers, et cetera such that the received data may be displayed. The radio interface 554 also provides data from the processing module 550 to the radio 560. The processing module 550 may receive the outbound data from an input device such as a keyboard, keypad, microphone, et cetera via the input interface 558 or generate the data itself. For data received via the input interface 558, the processing module 550 may perform a corresponding host function on the data and/or route it to the radio 560 via the radio interface 554.

Radio 560 includes a host interface 562, a baseband processing module 564, memory 566, a plurality of radio frequency (RF) transmitters 568-372, a transmit/receive (T/R) module 574, a plurality of antennae 582-386, a plurality of RF receivers 576-380, and a local oscillation module 5100 (which may be implemented, at least in part, using a VCO). The baseband processing module 564, in combination with operational instructions stored in memory 566, execute digital receiver functions and digital transmitter functions, respectively. The digital receiver functions, include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions, include, but are not limited to, scrambling, encoding, interleaving, constellation mapping, modulation, inverse fast Fourier transform, cyclic prefix addition, space and time encoding, and/or digital baseband to IF conversion. The baseband processing modules 564 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 566 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 564 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 560 receives outbound data 588 from the host device via the host interface 562. The baseband processing module 564 receives the outbound data 588 and, based on a mode selection signal 5102, produces one or more outbound symbol streams 590. The mode selection signal 5102 will indicate a particular mode as are illustrated in the mode selection tables, which appear at the end of the detailed discussion. Such operation as described herein is exemplary with respect to at least one possible embodiment, and it is of course noted that the various aspects and principles, and their equivalents, of the invention may be extended to other embodiments without departing from the scope and spirit of the invention.

For example, the mode selection signal 5102, with reference to table 1 may indicate a frequency band of 2.4 GHz or 5 GHz, a channel bandwidth of 20 or 22 MHz (e.g., channels of 20 or 22 MHz width) and a maximum bit rate of 54 megabits-per-second. In other embodiments, the channel bandwidth may extend up to 1.28 GHz or wider with supported maximum bit rates extending to 1 gigabit-per-second or greater. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. As is further illustrated in table 1, a code rate is supplied as well as number of coded bits per subcarrier (NBPSC), coded bits per OFDM symbol (NCBPS), and data bits per OFDM symbol (NDBPS).

The mode selection signal may also indicate a particular channelization for the corresponding mode which for the information in table 1 is illustrated in table 2. As shown, table 2 includes a channel number and corresponding center frequency. The mode select signal may further indicate a power spectral density mask value which for table 1 is illustrated in table 3. The mode select signal may alternatively indicate rates within table 4 that has a 5 GHz frequency band, 20 MHz channel bandwidth and a maximum bit rate of 54 megabits-per-second. If this is the particular mode select, the channelization is illustrated in table 5. As a further alternative, the mode select signal 5102 may indicate a 2.4 GHz frequency band, 20 MHz channels and a maximum bit rate of 192 megabits-per-second as illustrated in table 6. In table 6, a number of antennae may be utilized to achieve the higher bit rates. In this instance, the mode select would further indicate the number of antennae to be utilized. Table 7 illustrates the channelization for the set-up of table 6. Table 8 illustrates yet another mode option where the frequency band is 2.4 GHz, the channel bandwidth is 20 MHz and the maximum bit rate is 192 megabits-per-second. The corresponding table 8 includes various bit rates ranging from 12 megabits-per-second to 216 megabits-per-second utilizing 2-4 antennae and a spatial time encoding rate as indicated. Table 9 illustrates the channelization for table 8. The mode select signal 102 may further indicate a particular operating mode as illustrated in table 10, which corresponds to a 5 GHz frequency band having 40 MHz frequency band having 40 MHz channels and a maximum bit rate of 486 megabits-per-second. As shown in table 10, the bit rate may range from 13.5 megabits-per-second to 486 megabits-per-second utilizing 1-4 antennae and a corresponding spatial time code rate. Table 10 further illustrates a particular modulation scheme code rate and NBPSC values. Table 11 provides the power spectral density mask for table 10 and table 12 provides the channelization for table 10.

It is of course noted that other types of channels, having different bandwidths, may be employed in other embodiments without departing from the scope and spirit of the invention. For example, various other channels such as those having 80 MHz, 120 MHz, and/or 160 MHz of bandwidth may alternatively be employed such as in accordance with IEEE Task Group ac (TGac VHTL6).

The baseband processing module 564, based on the mode selection signal 5102 produces the one or more outbound symbol streams 590 from the output data 588. For example, if the mode selection signal 5102 indicates that a single transmit antenna is being utilized for the particular mode that has been selected, the baseband processing module 564 will produce a single outbound symbol stream 590. Alternatively, if the mode select signal indicates 2, 3 or 4 antennae, the baseband processing module 564 will produce 2, 3 or 4 outbound symbol streams 590 corresponding to the number of antennae from the output data 588.

Depending on the number of outbound streams 590 produced by the baseband module 564, a corresponding number of the RF transmitters 568-372 will be enabled to convert the outbound symbol streams 590 into outbound RF signals 592. The transmit/receive module 574 receives the outbound RF signals 592 and provides each outbound RF signal to a corresponding antenna 582-386.

When the radio 560 is in the receive mode, the transmit/receive module 574 receives one or more inbound RF signals via the antennae 582-386. The T/R module 574 provides the inbound RF signals 594 to one or more RF receivers 576-380. The RF receiver 576-380 converts the inbound RF signals 594 into a corresponding number of inbound symbol streams 596. The number of inbound symbol streams 596 will correspond to the particular mode in which the data was received (recall that the mode may be any one of the modes illustrated in tables 1-12). The baseband processing module 560 receives the inbound symbol streams 590 and converts them into inbound data 598, which is provided to the host device 318-332 via the host interface 562.

In one embodiment of radio 560 it includes a transmitter and a receiver. The transmitter may include a MAC module, a PLCP module, and a PMD module. The Medium Access Control (MAC) module, which may be implemented with the processing module 564, is operably coupled to convert a MAC Service Data Unit (MSDU) into a MAC Protocol Data Unit (MPDU) in accordance with a WLAN protocol. The Physical Layer Convergence Procedure (PLCP) Module, which may be implemented in the processing module 564, is operably coupled to convert the MPDU into a PLCP Protocol Data Unit (PPDU) in accordance with the WLAN protocol. The Physical Medium Dependent (PMD) module is operably coupled to convert the PPDU into a plurality of radio frequency (RF) signals in accordance with one of a plurality of operating modes of the WLAN protocol, wherein the plurality of operating modes includes multiple input and multiple output combinations.

An embodiment of the Physical Medium Dependent (PMD) module includes an error protection module, a demultiplexing module, and a plurality of direction conversion modules. The error protection module, which may be implemented in the processing module 564, is operably coupled to restructure a PPDU (PLCP (Physical Layer Convergence Procedure) Protocol Data Unit) to reduce transmission errors producing error protected data. The demultiplexing module is operably coupled to divide the error protected data into a plurality of error protected data streams The plurality of direct conversion modules is operably coupled to convert the plurality of error protected data streams into a plurality of radio frequency (RF) signals.

It is also noted that the wireless communication device of this diagram, as well as others described herein, may be implemented using one or more integrated circuits. For example, the host device may be implemented on one integrated circuit, the baseband processing module 564 and memory 566 may be implemented on a second integrated circuit, and the remaining components of the radio 560, less the antennae 582-586, may be implemented on a third integrated circuit. As an alternate example, the radio 560 may be implemented on a single integrated circuit. As yet another example, the processing module 550 of the host device and the baseband processing module 564 may be a common processing device implemented on a single integrated circuit. Further, the memory 552 and memory 566 may be implemented on a single integrated circuit and/or on the same integrated circuit as the common processing modules of processing module 550 and the baseband processing module 564.

The previous diagrams and their associated written description illustrate some possible embodiments by which a wireless communication device may be constructed and implemented. In some embodiments, more than one radio (e.g., such as multiple instantiations of the radio 460, the radio 560, a combination thereof, or even another implementation of a radio) is implemented within a wireless communication device. For example, a single wireless communication device can include multiple radios therein to effectuate simultaneous transmission of two or more signals. Also, multiple radios within a wireless communication device can effectuate simultaneous reception of two or more signals, or transmission of one or more signals at the same time as reception of one or more other signals (e.g., simultaneous transmission/reception).

Within the various diagrams and embodiments described and depicted herein, wireless communication devices may generally be referred to as WDEVs, DEVs, TXs, and/or RXs. It is noted that such wireless communication devices may be wireless stations (STAs), access points (APs), or any other type of wireless communication device without departing from the scope and spirit of the invention. Generally speaking, wireless communication devices that are APs may be referred to as transmitting or transmitter wireless communication devices, and wireless communication devices that are STAs may be referred to as receiving or receiver wireless communication devices in certain contexts.

Of course, it is noted that the general nomenclature employed herein wherein a transmitting wireless communication device (e.g., such as being an AP, or a STA operating as an ‘AP’ with respect to other STAs) initiates communications, and/or operates as a network controller type of wireless communication device, with respect to a number of other, receiving wireless communication devices (e.g., such as being STAs), and the receiving wireless communication devices (e.g., such as being STAs) responding to and/or cooperating with the transmitting wireless communication device in supporting such communications.

Of course, while this general nomenclature of transmitting wireless communication device(s) and receiving wireless communication device(s) may be employed to differentiate the operations as performed by such different wireless communication devices within a communication system, all such wireless communication devices within such a communication system may of course support bi-directional communications to and from other wireless communication devices within the communication system. In other words, the various types of transmitting wireless communication device(s) and receiving wireless communication device(s) may all support bi-directional communications to and from other wireless communication devices within the communication system.

Various aspects and principles, and their equivalents, of the invention as presented herein may be adapted for use in various standards, protocols, and/or recommended practices (including those currently under development) such as those in accordance with IEEE 802.11x (e.g., where x is a, b, g, n, ac, ah, ad, af, etc.).

A novel manner is presented herein by which communications are supported from a transmitter wireless communication device to a number of receiver wireless communication devices. In the context of providing video communications via wireless means, certain considerations are made with respect to the variability, sometimes unpredictability, and particular characteristics of wireless communications. For example, a wireless communication channel may be susceptible to significantly and relatively more interference, noise, and other deleterious problems when compared to a wired communication channel. When providing video communications via such wireless communication channels, certain considerations may be made that are not necessary with respect to video communications via wired communication channels.

Generally speaking, various embodiments described herein relate to a given transmitting wireless communication device is operative to provide media signaling (e.g., video signaling, audio signaling, etc.) and information to at least one receiving wireless committees device. In certain embodiments, a given transmitter wireless communication device is operative to provide streaming video to a number of receiving wireless communication devices, and such an embodiment may generally be referred to as a point to multipoint wireless media (e.g., video and/or audio, etc.) communication system. Such streaming video may be provided simultaneously from a common transmitter wireless communication device to a number of wireless receiver (e.g., communication devices) intending to receive media delivery.

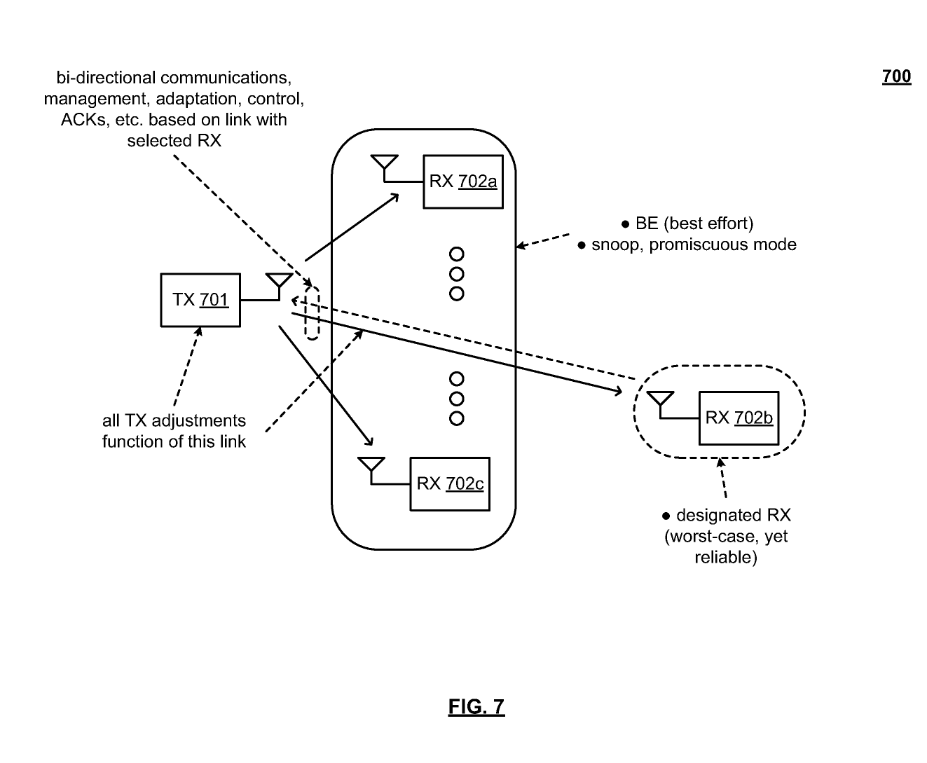

FIG. 6 is a diagram illustrating an embodiment 600 of supporting communications from a transmitter wireless communication device to a number of receiver wireless communication devices based on a selected, designated, or leader receiver wireless communication device. With respect to this diagram, a given transmitter wireless communication device 601 is operative to provide video signaling (e.g., streaming video) to a number of receiver wireless communication devices 602a, 602b, 602c, and so on up to 602d. Amongst all the receiving wireless communication devices, one device is selected (e.g., RX 602c in this embodiment 600) to be a selected, designated, or leader target for transmitting media thereto. In certain embodiments, the selection of the designated receiver (e.g., 602c in this embodiment) is performed or done by the transmitter wireless communication device 601. In alternative embodiments, the selection of such a designated receiver is made cooperatively by the transmitter wireless communication device 601 and one or more of the receiver wireless communication devices (e.g., which may or may not include the designated receiver wireless communication device 602c). Such decision-making may be made in accordance with any of a variety of conditions, constraints, parameters, etc.

For example, any one or more of signal to noise ratio, error rate, channel estimation, channel characterization, interference, noise, etc. associated with the various receiver wireless communication devices and their respective communication links may be employed by a transmitter wireless communication device 601 in accordance with selecting the ‘selected’, ‘designated’, or ‘leader’ receiver wireless communication device. In an alternative embodiment, the various receiver wireless communication devices cooperatively decide which among them is to be the ‘selected’, ‘designated’, or ‘leader’ receiver wireless communication device, and at least one of them provide such indication information to the transmitter wireless communication device 601. In yet another embodiment, one or more of the various receiver wireless communication devices and the transmitter wireless communication device 601 cooperatively decide which receiver wireless communication device is to be the ‘selected’, ‘designated’, or ‘leader’ receiver wireless communication device. Generally speaking, at any given time, that receiver wireless communication device that is selected or designated as being that receiver wireless communication device to which media communications are tailored and adapted may be referred to as a leader wireless communication device, selected wireless communication device, designated wireless communication device, and/or equivalent, etc. Such terminology may be used interchangeable in various embodiments, diagrams, description, etc. herein.

With respect to tailoring the different and respective communication signals provided respectively to the various receiver wireless communication devices 602a-602d, all of the signals communicated from the transmitter wireless communication device 601 to the various receiver wireless communication devices 602a-602d are either based on one or more parameters associated with the designated receiver wireless communication device 602c, or are based on a common set of parameters suited for all or a subset of the receiver wireless communication devices intending to receive the media delivery. For example, selection of one of the receiver wireless communication devices 602a-602d as being the designated receiver wireless communication device may be made in accordance with consideration of media delivery to all or a subset of the receiver wireless communication devices 602a-602d. In such an embodiment, the decision-making of which of the receiver wireless communication devices 602a-602d is to be the from the transmitter wireless communication device 601 to all or a subset of the receiver wireless communication devices 602a-602d. That is to say, while certain embodiments presented herein relate to selecting a designated receiver wireless communication device based upon its ability to receive media at a relatively lowest, yet acceptable level, other embodiments operate to consider various characteristics of all or a subset of the receiver wireless communication devices 602a-602d (e.g., considering those receiver wireless communication devices beyond only one of the receiver wireless communication devices such as the designated receiver wireless communication device).

Various characteristics associated with delivering media from the transmitter wireless communication device 601 (TX) to all or a subset of the receiver wireless communication devices 602a-602d (RXs) may include any one or more of respective abilities of those RXs for receiving communications from the TX, respective abilities of those RXs for supporting communications with other of the RXs, the respective abilities of the RXs for resending communications originally received from the TX to other of the RXs (e.g., in accordance with a resending or forwarding implementation), respective user usage information of the RXs (e.g., processing history, user interactive history, etc.), respective communication capabilities of the RXs (e.g., certain RXs may be only compatible with legacy standards, protocols, etc. while others may be compatible with newer standards, protocols, etc., MIMO capabilities, etc.), respective communication histories of the RXs (e.g., prior media receipt history, prior uplink transmission history, etc.), respective energy constraints of the RXs (e.g., energy consumption history, energy constraint information [such as available energy source information—battery vs. power outlet, remaining energy level], etc.), respective acknowledgment (ACK) histories of the RXs, and/or respective negative acknowledgment (N-ACK) histories of the RXs, etc. Yet other characteristics associated with delivering media from the TX to all or a subset of the RXs may relate to the respective latencies associated with the different respective communication paths or links from the TX to those respective RXs, the respective media (e.g., video) qualities that may be supported along those different respective communication paths or links from the TX to those respective RXs, and/or the respective bandwidth requirements associated with delivering media to those respective RXs.

Generally speaking, any one or more of such characteristics may be used to select one of the RXs as being the designated RX. Moreover, in different respective implementations, different of these characteristics may be relatively weighted differently than others. For example, in one possible embodiment, the respective communication histories of one or more of the RXs may be of relatively greater importance and weighted significantly more heavily than other of the characteristics. In yet another embodiment, the respective abilities of one or more of the RXs to perform resending of communications originally received from the TX relatively greater importance and weighted significantly more heavily than other of the characteristics. In one embodiment, one or more vectors or matrices (or an adaptive vector or matrix) may be employed such that the relative weighting of the respective characteristics may be tailored and adapted for a given application.

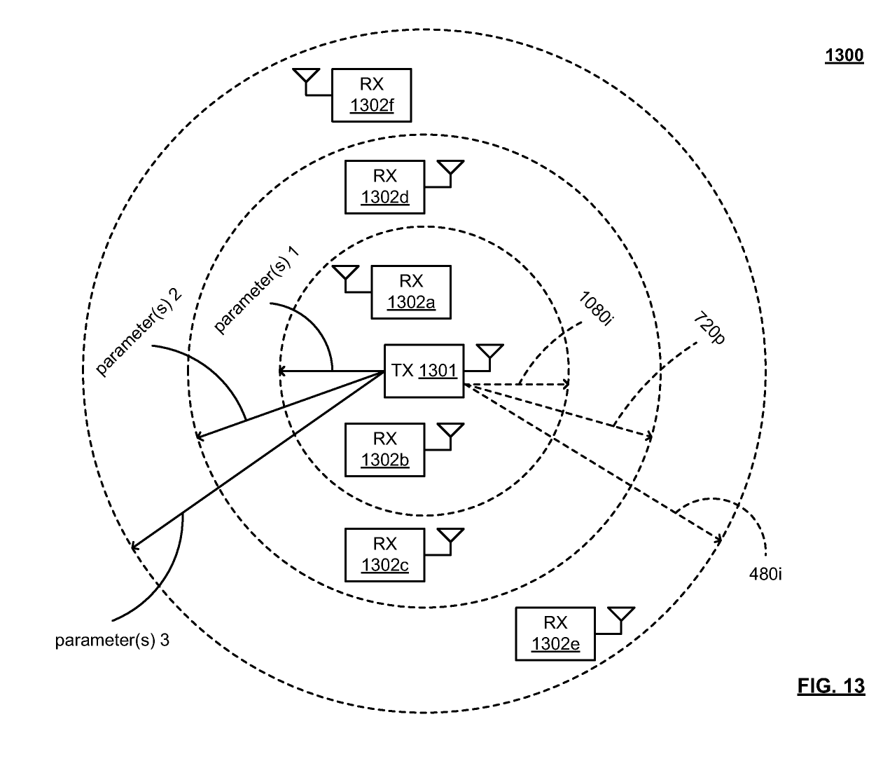

As can be seen, certain embodiments are directed towards deciding which of the RXs is to be the designated RX based upon consideration of characteristics associated with all or a subset of the RXs (e.g., some embodiments, at least one RX may end up being excluded). In certain embodiments, selection of the designated RX is based upon ensuring that a majority of the RXs receive a majority of the media delivered thereto. Generally speaking, consideration is provided to more than one characteristic associated with more than one of the RXs (e.g., beyond selecting a designated RX based upon that RX having the relatively highest error rate, yet still being acceptable) in selecting a designated RX. As also described elsewhere herein and with respect to other diagrams and/or embodiments, given the inherent characteristics and sometimes limitations of wireless communication channels or links, it may be undesirable and in some cases impractical or even impossible to allow all or a subset of the RXs to provide acknowledgments (ACKs) and/or negative acknowledgments (N-ACKs) to the TX. As such, multi-faceted decision-making for identifying the designated RX may provide for improved overall system performance. For example, such selection of the designated RX may be made using any one or more, or any combination (e.g., subset) of the various characteristics associated with delivering media from a TX to all or a subset of RXs. Also, any desired relative weighting of those one or more characteristics may be employed in a given instance, including modifying or adapting the relative weighting based upon a given application context. Once such a designated RX is identified, one or more operational parameters may then be identified for delivering the media from the TX to all or the subset of RXs. Such considerations as described for selecting a designated RX may be generally applied to any of the various embodiments and/or diagrams included herein, including those in which a number of RXs are further subdivided within different respective groups (e.g., such as with respect to FIG. 11).

It is also noted that, while many embodiments and/or diagrams included herein relate to selecting a singular designated RX, alternative embodiments may include at least one additional designated RX such that both the first designated RX and the at least a second designated RX may provide ACKs and/or N-ACKs to the RX. However, generally, a number of designated RXs will be less (e.g., oftentimes much less) than the total number of RXs to which media is being delivered from the RX.

Such communications from the transmitter wireless communication device 601 to the various receiver wireless communication devices 602a-602d are provided in parallel with one another and/or simultaneously with respect to each other in certain embodiments. For example, in one embodiment, the transmitter wireless communication device 601 is operative to provide simultaneous streaming video to each of the respective transmitter wireless communication device 601. It is noted that while such a simultaneous streaming video signal may be provided to each of the respective receiver wireless communication devices 602a-602d, each respective receiver wireless communication devices 602a-602d may be operative to tune to a different respective video-channel, programming, signal component, etc. within that, in simultaneous streaming video signal such that each respective receiver wireless communication devices 602a-602d may output a different respective channel, programming, signal component, etc. For example, as may also be understood with respect to FIG. 11, different respective groups of receiver wireless communication devices may each respectively be operative to tune to a different respective video-channel, programming, signal component, etc. within that, in simultaneous streaming video signal such that each respective receiver wireless communication devices may output a different respective channel, programming, signal component, etc. (e.g., a first group may tune in accordance with a first one or more tuning parameters, a second group may tune in accordance with a second one or more tuning parameters, etc.). Generally speaking, such selective tuning may be performed on a group by group basis, a device by device basis, a combination of group/device basis, etc.

From certain perspectives, the operation of such a wireless communication system may be viewed as being somewhere between a multicast implementation and a unicast implementation. As unicast implementation may be viewed generally as an embodiment in which signaling is transmitted from a transmitter wireless communication device to a receiver wireless communication device as identified by a particular and unique address. In accordance with unicast operations, oftentimes acknowledgment capability is provided. That is to say, bi-directional communications are supported between the transmitter wireless communication device and the singular receiver wireless communication device. Based upon such acknowledgment capability and/or feedback capability that is provided from the receiver wireless communication device and the transmitter wireless communication device, one or more operational parameters by which such signaling is provided from the transmitter wireless communication device to the receiver wireless communication device are decided. Any of a number of operational parameters may be adaptively adjusted based upon such feedback. Examples of such operational parameters include bit rate, symbol rate, code rate, type of code, resolution (e.g., such as with respect to photographic and/or video content), modulation type, and/or any other operational parameter which may be used to effectuate wireless communications between the two communication devices, etc. It is noted also that such acknowledgments (provided upstream) need not be provided within the same frequency band(s) via which the downstream communications are provided. That is to say, such acknowledgments may be provided in band or out of band with respect to the downstream communications. For example, in certain embodiments, one or more different respective bands may be employed and/or dedicated for upstream communications, and such an out of band acknowledgment may be made via those one or more different respective bands.

In comparison, a multicast implementation may be viewed generally as an embodiment in which signaling is transmitted from a transmitter communication device to a number of receiver wireless communication devices. Generally speaking, multicast communications do not employ such acknowledgment capability. Also, generally speaking multicast communications do not typically employ respective feedback from the respective receiver wireless communication devices within the system.

With respect to the embodiment depicted herein, among a group of receiver wireless communication devices, one receiver wireless communication device is selected, designated, identified, etc. as being that wireless communication device within a group of receiver wireless communication devices that is operative to support bi-directional communications with a transmitter wireless communication device and for which media communications are tailored and/or adapted. The delivery of communications from the transmitter wireless communication device may be viewed as being effectuated in accordance with a modified multicast manner. Stated another way, the delivery of communications from the transmitter wireless communication device may be viewed as being effectuated in accordance with multicast yet being modified such that management therein is handled in accordance with unicast.

For example, while communications may be provided simultaneously and/or in parallel with respect to each other from the transmitter wireless communication device, one of the receiver wireless communication devices (e.g., the designated receiver wireless communication device) is operative to perform as a bi-directional mutation leader. In certain embodiments, the selected receiver wireless communication device may be viewed as being the acknowledgment leader among the receiver wireless communication devices. For example, such an embodiment may be viewed as a modified multicast implementation with a designated acknowledgment leader.

The communication channel between the transmitter wireless communication device 601 and the designated (or leader, selected, etc.) receiver wireless communication device 602c is the wireless communication channel for which tailoring and/or adjustment of communications from the transmitter wireless communication device 601 to the multiple receiver wireless communication devices 602a-602d is made. That is to say, one or more operational parameters as may be adaptively determined and/or adaptively adjusted to support communications between the transmitter wireless communication device and this particular receiver wireless communication device 602c are those operational parameters which are used to support communications from the transmitter wireless communication device 601 to the multiple receiver wireless communication devices 602a-602d. Also, it is noted that a common set of operational parameters may be selected as being most appropriately suited for all or a subset of the multiple receiver wireless communication devices 602a-602d. For example, while certain embodiments select one or more operational parameters as being particularly suited for delivering media to the designated receiver wireless communication device 602c, other embodiments may select one or more parameters as being particularly suited for all or a subset of the multiple receiver wireless communication devices 602a-602d. As can be seen, different embodiments may select one or more operational parameters based on different respective criteria.

Within this embodiment as with respect to others, it is noted that while certain of the wireless communication devices are depicted generally as being transmitters (e.g., TXs) and other of the wireless communication devices are depicted generally as being receivers (e.g., RXs), any of the respective wireless communication devices within such embodiments may be operative to support bi-directional communications. That is to say, while a majority of communications within such an embodiment may flow from the transmitter wireless communication device 601 to the various receiver wireless communication devices 602a-602d (e.g., in accordance with what may be described as downstream communications), it is noted that communications may nonetheless be directed from the receiver wireless communication devices 602a-602d to the transmitter wireless communication device 601 (e.g., in accordance with what may be described as upstream communications, such as in accordance with feedback, acknowledgments, channel estimation information, channel characterization information, and/or any other types of communications). Generally speaking, communications from the transmitter wireless communication device 601 to the receiver wireless communication devices 602a-602d may be described as being downstream communications, while communications from the receiver wireless communication devices 602a-602d to the transmitter wireless communication device 601 may be described as being upstream communications. The nomenclature associated with transmitter and receiver wireless communication devices is employed herein with respect to the point to multipoint type communications.

The reader will appropriately understand that while a majority of communications are effectuated in the downstream direction (e.g., from TX to one or more RXs), there may of course be some communications effectuated in the upstream direction (e.g., from one or more RXs to the TX). For example, in certain embodiments, the RXs have an option to send upstream communications in response to an inquiry from the TX. For example, such upstream communications may be special packets, and such upstream communications may inform the TX about a particular sequence number of packets received by that given RX. The TX may then selectively retry or retransmit lost sequence numbers bi-directionally to those RXs failing to receive certain downstream communications. However, in such an instance, the bi-directional traffic may not be particularly associated with the selected RX, but such bi-directional traffic may be associated with that particular RX that is reporting one or more lost downstream communications. For example, considering the selected RX as an ACK-leader, while bi-directional communications between such an ACK-leader and the TX may be supported generally, there may be some instances in which bi-directional traffic is also supported between other RXs and the TX (e.g., such as in accordance with reporting of lost packets). For example, in certain embodiments, the TX may include a cache or buffer to keep relatively recent downstream communications (e.g., those which have been made within a recent period of time), and upon the request of a retry or retransmission from one of the RXs, the TX will then have immediate access to such communications and may perform a retransmission thereof to that RX that is requesting the retry or retransmission.

In addition, it is noted that while various of the embodiments and diagrams described herein are directed towards wireless communication devices and wireless communication systems, such operations and functionality may generally be applied to any type of communication devices and communication systems. For example, as described elsewhere herein such as with respect to FIG. 1, certain communication systems may be a combination of different types of communication systems (e.g., wireless, wired, fiber optic, satellite, and/or any combination thereof). Generally speaking, such point to multi point communications and management thereof as described herein may be applied to any type of communication device. For example, in some situations, a communication system may be a wired communication system. One such type of wired communication system may be implemented such that a cable modem termination system (CMTS) or headend transmitter is implemented as the TX, and various respective cable modems (CMs) are implemented as the RXs. In such an embodiment, one of the CMs may be selected as the selected RX (e.g., the ACK-leader CM). Multicast type signaling, and one or more operational parameters associated with, from the CMTS to the respective CMs may be based upon characteristics associated with that selected CM and/or the communication link between the CMTS and that selected CM. Another type of wired communication system may be implemented such that a digital subscriber line access multiplexer (DSLAM) is operative to provide multicast type signaling to a number of users connected thereto via a number of digital subscriber lines (DSLs). Other wired communication system applications may include those which are implemented via a power line-based network, one operating in accordance with multimedia over coax alliance (MoCA®, or generally referred to as MoCA), etc.

Generally speaking, the respective communication links between a TX and a number of RXs may be implemented using different types of media (e.g., a first communication link may be wireless, a second communication link may be wired, a third communication link may be fiber-optic, etc.). The various operations and functionality presented herein may be generally applied to any type of communication system having respective communication links implemented using any desired type of communication media and/or combination of medication media.

Also, certain applications may require specifically tailored information to be provided from the TX to different respective receiver wireless communication devices within the multiple receiver wireless communication devices 602a-602d. For example, within a navigation system application, there may be specific and separate content that may be provided to different RXs (e.g., information 1 for a first RX, information 2 for a second RX, etc.). That is to say, each of the different and multiple receiver wireless communication devices 602a-602d may be provided specific and separate spectral content.

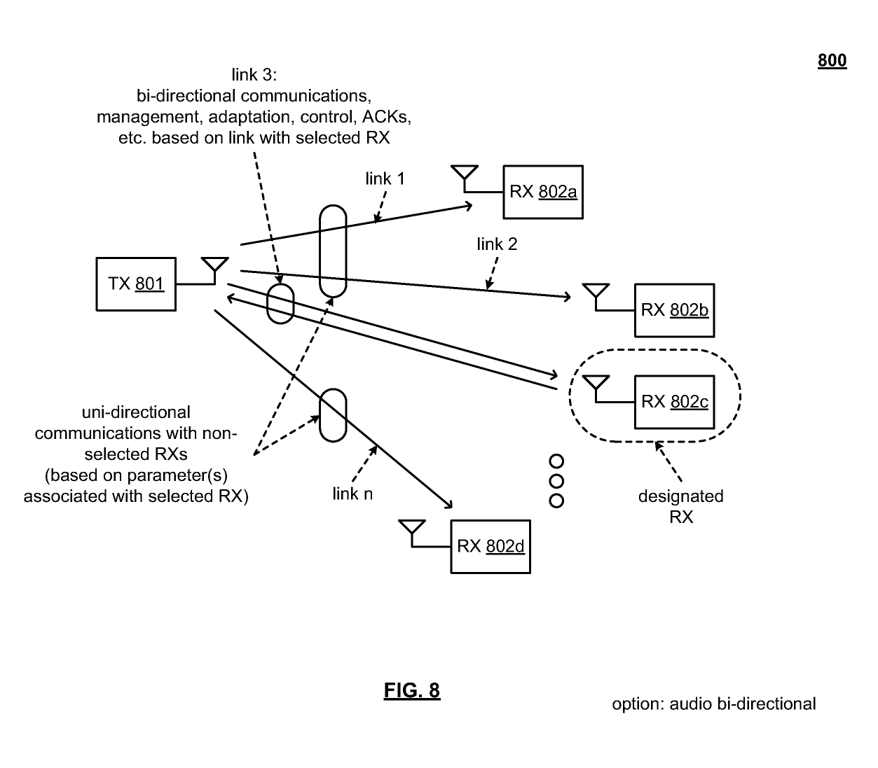

FIG. 7 is a diagram illustrating an embodiment 700 of supporting communications from a transmitter wireless communication device to a number of receiver wireless communication devices in accordance with best effort and particularly with respect to tailoring, adapting, and/or adjusting operational parameters with respect to a selected or designated one of the receiver wireless communication devices operate. With respect to this diagram, it may be seen that among a number of potential recipients of communications from transmitter wireless communication device 701, one of them is selected (e.g., selected receiver wireless communication device 702b in this embodiment). This particular receiver wireless communication device 702b is selected as being a wireless communication device operative to receive communications from the transmitter wireless communication device 701 to an acceptable and sufficient degree using an active feedback mechanism as in uni-cast transmissions (e.g., the operation of which may generally be referred to as being modified multi-casting). For example, such considerations regarding the adequacy of receiving such communications may be based upon a sufficiently high signal-to-noise ratio, a sufficiently low error rate (e.g., bit error rate, block error rate, symbol error rate, etc.), with a sufficiently low number of requests for retransmission, etc. It is noted that different respective constraints (e.g., thresholds) may be respectively employed for each of a number of considerations used to characterize the adequacy of receiving such communications. Of course, any one or more of the considerations may be respectively weighted more than others in accordance with any multidimensional characterization or decision-making processing.

Again, in the context of communications including video information (e.g., streaming video), the receiver wireless communication device 702b is that wireless communication device that is operative to receive media signaling (e.g., video signaling, audio signaling, etc.) from the transmitter wireless communication device 701 within an acceptable and sufficient degree. In a preferred embodiment, one of the receiver wireless communication devices is selected, designated, etc. as being that which is sufficiently reliable yet is the overall worst case receiver that can still receive media delivery at an acceptable level. For example, in some embodiments, at least one criterion for selecting a designated receiver wireless communication device may be based upon that receiver wireless communication device which provides the minimum packet error rate (PER) across all receiver wireless medication devices. That is to say, in such an embodiment, the designated (alternatively, selected, leader, etc.) receiver wireless communication device is that which is the overall worst case performing receiver wireless communication device yet is nonetheless operative to receive media signaling (e.g., video signaling, audio signaling, etc.) from the transmitter wireless communication device 701 in an acceptably reliable manner.

Communications from the transmitter wireless communication device 701 are effectuated based upon characteristics associated with the communication link between the transmitter wireless communication device 701 and receiver wireless communication device 702b. For example, in some embodiments, any of a number of operational parameters employed to effectuate communications from the transmitter wireless communication device 701 to the various receiver wireless communication devices 702a-702c are determined and/or adjusted based upon the communication link between the transmitter wireless communication device 701 and receiver wireless communication device 702b. However, in other alternative embodiments, such operational parameters employed to effectuate communications from the transmitter wireless communication device 701 the various receiver wireless communication devices 702a-702c are determined and/or adjusted based upon consideration of the multiple respective communication links between the transmitter wireless communication device 701 and multiple receiver wireless communication devices 702a-702c (e.g., including the respective communication links of the non-designated devices); in other words, consideration is made with respect to more than one of the communication links. Then, when one of the receiver wireless communication devices 702a-702c is selected as the designated receiver wireless communication device 702b, then the appropriate operational parameters may be tailored and/or adapted based on that designated devices respective communication link.

As with respect to certain other embodiments, some examples of such operational parameters include bit rate, symbol rate, code rate, type of code, resolution (e.g., such as with respect to photographic and/or video content), modulation type, and/or any other operational parameter which may be used to effectuate wireless communications between the two communication devices, etc.

in one embodiment, once the receiver wireless communication device 702b has been selected (alternatively, designated, etc.), and one or more operational parameters by which communications from the transmitter wireless communication device 701 are selected and/or determined, then communications may be provided from the transmitter wireless communication device 701 to each of the various receiver wireless communication devices 702a-702c. All communications to the various receiver wireless communication devices 702a-702c are then effectuated in accordance with information based upon the receiver wireless communication device 702b and the communication link between the transmitter wireless communication device 701 and the designated receiver wireless communication device 702b.

That is to say, respective downstream media communications to all other non-designated receiver wireless communication devices 702a-702c are provided in similar manner as the downstream media communications to the designated receiver wireless communication device 702b. In one embodiment, at least one of the non-designated receiver wireless communication devices 702a-702c operates in accordance with a snooping or promiscuous mode of operation. For example, certain alternative embodiments may operate in which more than one of the receiver wireless communication devices 702a-702c are selected as being designated receiver wireless communication devices (e.g., such that each of those two or more designated receiver wireless communication devices provide information upstream to the transmitter wireless communication device 701, and the transmitter wireless communication device 701 tailors and/or adapts one or more operational parameters based upon some combination of those upstream communications from those two or more designated receiver wireless communication devices). In another possible embodiment, all of the non-designated receiver wireless communication devices 702a-702c operate in accordance with a best effort mode of operation.

As the reader will understand, with respect to one possible embodiment, all of the non-designated receiver wireless communication devices 702a-702c operate in an effort to receive an appropriately process communications from the transmitter wireless communication device 701 even though those non-designated receiver wireless communication devices 702a-702c do not operate to determine and/or select the respective one or more operational parameters by which communications are effectuated from the transmitter wireless communication device 701.

As the reader will also understand, with respect to at least one other possible embodiment, even the non-designated receiver wireless communication devices may operate to determine and/or select the respective one or more operational parameters by which communications are effectuated from the transmitter wireless communication device 701. For example, in accordance with selecting one of the receiver wireless communication devices as being the designated receiver wireless communication device, the transmitter wireless communication device 701 may provide a unicast burst of packets to a first one of the receiver wireless communication devices and then requests feedback from all of the other receiver wireless communication devices. This process may be repeated for each of the other receiver wireless communication devices as well (e.g., provide a unicast burst of packets to a second one, a third one, etc. of the receiver wireless communication devices and then requests feedback respectively from all of the other receiver wireless communication devices). After such process has been repeated for each of the receiver wireless communication devices within the system, the one receiver wireless communication device providing the overall lowest packet error rate (PER) among all of the respective receiver wireless communication devices may be selected or designated as that receiver wireless communication device for which communications are tailored and/or adapted for media delivery to all or a subset of the receiver wireless communication devices.

Generally speaking, by tailoring the one or more operational parameters based upon the worst case yet sufficiently or acceptably reliable receiver wireless communication device 702b, those non-designated receiver wireless communication devices 702a-702c will be operative to receive such communications from the transmitter wireless communication device 701.

As can be seen within this diagram, communications between me TX 701 and the RX 702b may be effectuated in accordance with bi-directional communications. That is to say, the RX 702b may provide uplink communications to the TX 701 such that management, adaptation, control, etc. of the downstream communications may be made based upon such uplink communications.

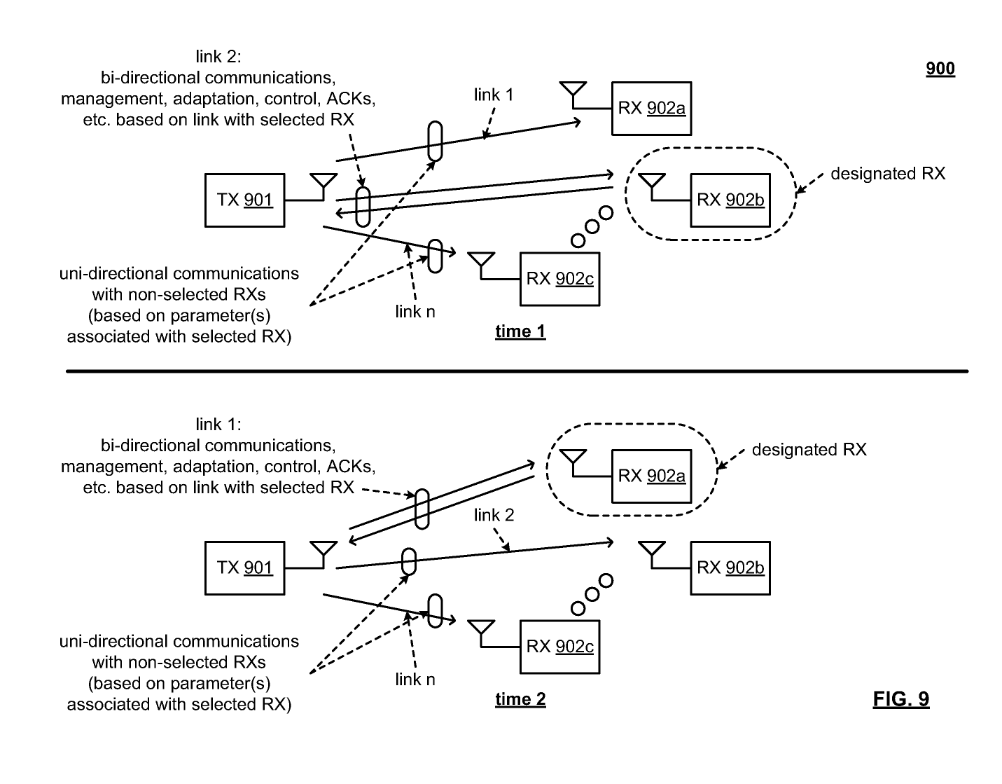

FIG. 8 is a diagram illustrating an embodiment 800 of supporting communications from a transmitter wireless communication device to a number of receiver wireless communication devices based on bi-directional communications (e.g., management, adaptation, control, acknowledgements (ACKs), etc.) with a designated one of the receiver wireless communication devices. With respect to this diagram, it can be seen that communications between a transmitter wireless communication device 801 and non-designated receiver wireless communication devices 802a-802d are all effectuated in a unidirectional manner. However, communications between transmitter wireless communication device 801 and receiver wireless communication device 802c (e.g., a designated receiver wireless communication device) are effectuated in a bi-directional manner. For example, any of a number of communications from receiver wireless to communication device 802c may be provided to the transmitter wireless communication device 801. Some examples of such upstream communications may include feedback, acknowledgments, channel estimation information, channel characterization information, and/or any other types of communications that may be provided for assistance, at least in part, for the transmitter wireless communication device 801 to determine and/or select one or more operational parameters by which communications are effectuated there from to the receiver wireless communication devices 802a-802b.

As may be understood with respect to the diagram, the unidirectional communications with the non-designated receiver wireless communication devices 802a-802d are based upon one or more operational parameters associated with the designated receiver wireless communication device 802c. Within this embodiment and also within various other embodiments included herein, it may be seen that communications from a given transmitter wireless communication device are effectuated in accordance with adaptation and control that is based upon one particular and selected communication link within the wireless communication system. Alternatively, a common set of parameters may be selected as being most appropriately suited for all or a subset of the receiver wireless communication devices intending to receive the media delivery. The other respective wireless communication links within the wireless communication system do not specifically govern the one or more operational parameters by which communications are effectuated, yet the respective receiver wireless communication devices associated with those other respective wireless communication links may nonetheless receive and process communications from the transmitter wireless communication device.

It is also noted that there may be certain operational parameters that a TX may adapt to ensure that such communications to the respective RXs are effective. However, there may be other operational parameters associated specifically with the designated RX that are not employed by the TX for providing downstream communications to the respective RXs. As one possible example, the designated RX may request or require beamforming, yet the TX may choose not to perform beamforming particularly tailored to the designated RX, as signaling provided to the other RXs may suffer degradation there from. It is of course noted that certain other operational parameters, and in some instances most or all operational parameters, are impacted by the designated RX (e.g., transmission rate, modulation type, etc.).

Also, as described elsewhere herein, there may be instances in which a non-designated RX (e.g., an RX that is not the ACK-leader) may request the retry or retransmission of one or more lost packets from the TX. In certain situations, the TX may select one or more operational parameters that are particularly tailored to that non-designated RX or the communication link between the TX and that non-designated RX.

In the context of communications including video information (e.g., streaming video), any of the respective receiver wireless communication devices is then operative to receive such video information from such a transmitter wireless communication device. However, again, it is the communication link between the transmitter wireless communication device and the designated receiver wireless communication device that is employed to determine and/or select the one or more operational parameters by which such video information is communicated to all of the receiver wireless communication devices. Alternatively, as also described elsewhere with respect to different diagrams and/or embodiments, a common set of parameters may be selected as being most appropriately suited for all or a subset of the receiver wireless communication devices intending to receive the media delivery.

In addition, it is noted that in certain situations, impairments may more significantly affect the audio component of communications than the video component of communications. That is to say, in a video signaling embodiment, in which video signaling provided from the transmitter wireless communication device 801 to the receiver wireless communication devices 802a-802b, the audio component may be more affected by impairments (e.g., considering that such video signaling is composed of both a video component and an audio component therein). In addition, sometimes audio traffic is provided at a relatively lower bit rate than video traffic. In certain embodiments, audio traffic may be handled in a bi-directional manner between the respective wireless communication devices. That is to say, while the video component of such video signaling may be handled in a unidirectional manner to all of the receiver wireless communication devices 802a-802b except for the designated receiver wireless communication device (in which case such video signaling is handled in a bi-directional manner), the audio component of such video signaling may be handled in a bi-directional manner to all of the receiver wireless communication devices 802a-802b.

In certain embodiments, an optional operational mode provides for the TX 801 to periodically send I-frames (only, for video) in accordance with video signaling to the designated RX 802c or to all of the RXs 802a-802d using uni-cast delivery. That is to say, and such an operational mode, respective I-frames need not necessarily be periodically sent to the other RXs that are not the designated RX 802c (e.g., those respective RXs may be provided only P-frames in accordance with video signaling).

In addition, it is noted that, in some embodiments, as least common denominator rate control may be employed for low latency video signaling in accordance with multicast. For example, a highest transmission rate they can be tolerated among all of the RXs while still providing an acceptable latency/packet error rate (PER) sharing the same designated RX. That is to say, the selection of the bit rate or transmission rate by which video signaling is provided to the RXs may be based upon consideration of characteristics associated with both the designated RX as well as certain other of the RXs. Such selection of one or more operational parameters used for the delivery and management of such communications between the TX and the several RXs is based upon a hybrid type decision-making that considers both the designated RX as well as other or all of the RXs and selects the highest, great providing the lowest packet error rate (PER) to all of the RXs. For example, any desired operational parameter by which the communication system operates may be designated in accordance with such hybrid type decision-making. In some instances, characteristics associated with the designated RX and the communication link between the TX and that designated RX may be weighted more heavily, or considered more importantly, then characteristics associated with other RXs and the respective communication links between the TX and those other RXs.

FIG. 9 is a diagram illustrating an embodiment 900 of supporting communications from a transmitter wireless communication device to a number of receiver wireless communication devices including adaptive selection of different receiver wireless communication devices for governing operation there among. As may be seen with respect to this diagram, a different receiver wireless communication device may be designated at different times.

For example, at time 1, receiver wireless communication device 902b may be designated as that receiver wireless communication device (and its respective communication link with transmitter wireless communication device 901) which is employed to determine and/or select the one or more operational parameters by which communications are effectuated to all of the receiver wireless communication devices 902a-902c.

Then, at time 2, another of the receiver wireless communication devices (e.g., receiver wireless communication device 902a) may be designated (and it's respective communication link with transmitter wireless communication device 901) as that particular receiver wireless communication device which is employed to determine and/or select, at least in part, the one or more operational parameters by which communications are effectuated to all of the receiver wireless communication devices 902a-902c.

Any of a number of conditions and/or constraints may be employed to trigger the selection of one of the receiver wireless communication devices for use as the particular receiver wireless communication device employed to determine and/or select the one or more operational parameters by which communications are effectuated to all of the receiver wireless communication devices 902a-902c. For example, such selection may be performed periodically after the elapse of certain periods of time (e.g., every X seconds, etc.). Alternatively, detection of certain conditions and/or the change of certain conditions may operate as a triggering event from which selection is performed. As one example, the communication link between a TX and the designated RX may improve, and such improvement may serve to trigger the selection of another RX to be the designated RX (e.g., the originally designated RX is no longer the least successfully receiving RX [yet at an acceptable level], such as having the relatively lowest packet error rate (PER), and another RX is designated whose packet error rate (PER) is relatively lower). It is also noted that the communication link between it TX and the designated RX may degrade to such a level (e.g., below some threshold) that that designated RX may no longer receive such signaling from the TX at an acceptable level. In such a case, a newly designated RX will replace the originally designated RX such that the newly designated RX, while being a least successfully receiving RX among a group, may still receive such signaling from the TX at an acceptable level.

Alternatively, such selection may be performed when the designated RX (e.g., that RX which is the ACK-leader) leaves the group or when a new RX joins the group; that is to say, a change in the RX participants of a given group may be employed to trigger the selection or reselection of that particular RX which will be employed to determine and/or select one or more operational parameters by which communications are affected to all of the RXs 902a-902c.

The reader will understand that there are a variety of conditions and/or constraints that may be employed to effectuate the selection or reselection of one of the receiver wireless communication devices for use in governing communications to all of the receiver wireless communication devices 902a-902c. Generally speaking, at different times, different respective receiver wireless communication devices may operate as the “designated” receiver wireless communication device, as may be seen with respect to this diagram.

At any given time or any given duration of time, communications between the transmitter wireless communication device 901 and the “designated” receiver wireless communication device are effectuated in accordance with bi-directional communications. At that same time or duration of time, communications between the transmitter wireless communication device 901 and the “non-designated” receiver wireless communication devices are effectuated in accordance with unidirectional communications. As the reader will then understand, at certain times, communications between a given receiver wireless communication device and the transmitter wireless communication device 901 may be effectuated in a bi-directional manner, and at other times, communications between a given receiver wireless communication device and the transmitter wireless communication device 901 may be effectuated in a unidirectional manner.

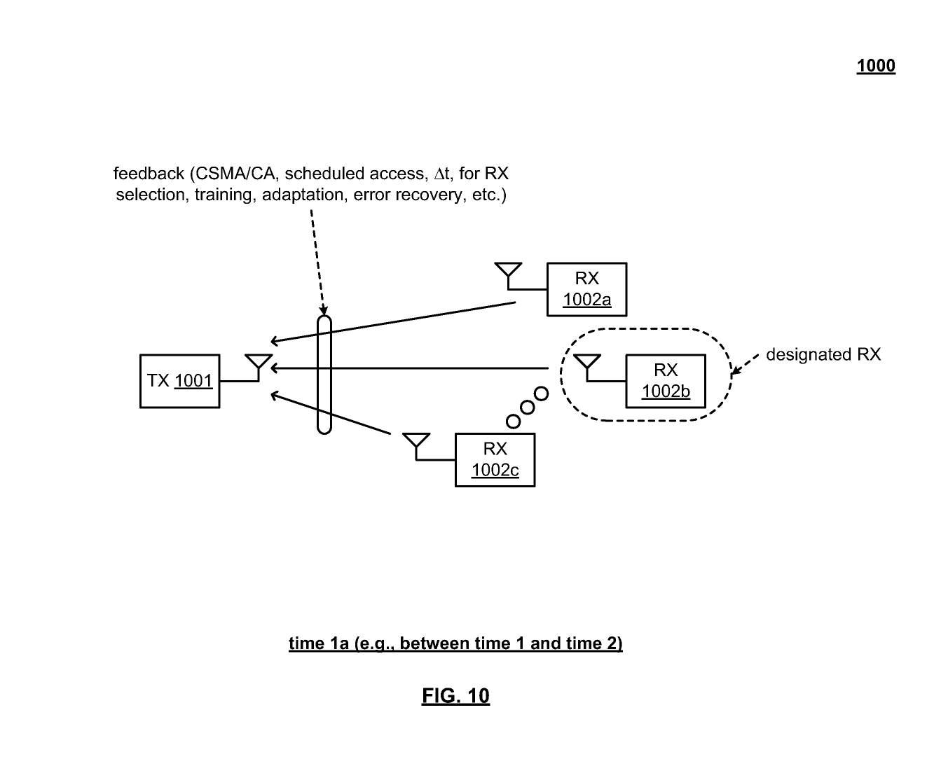

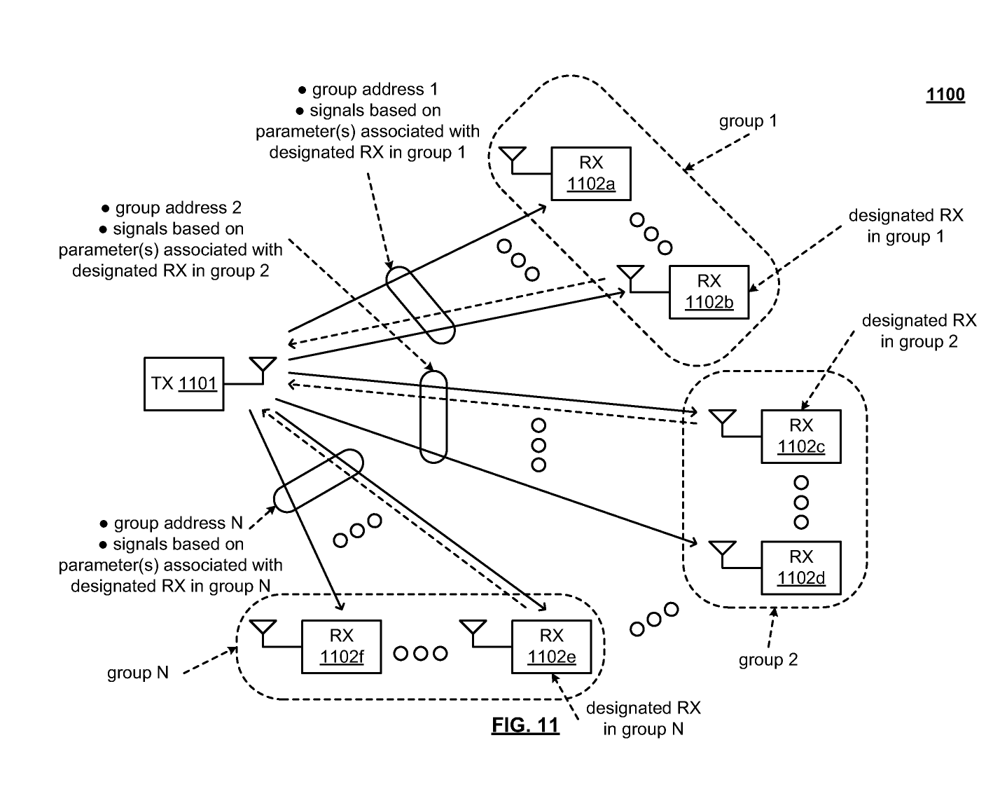

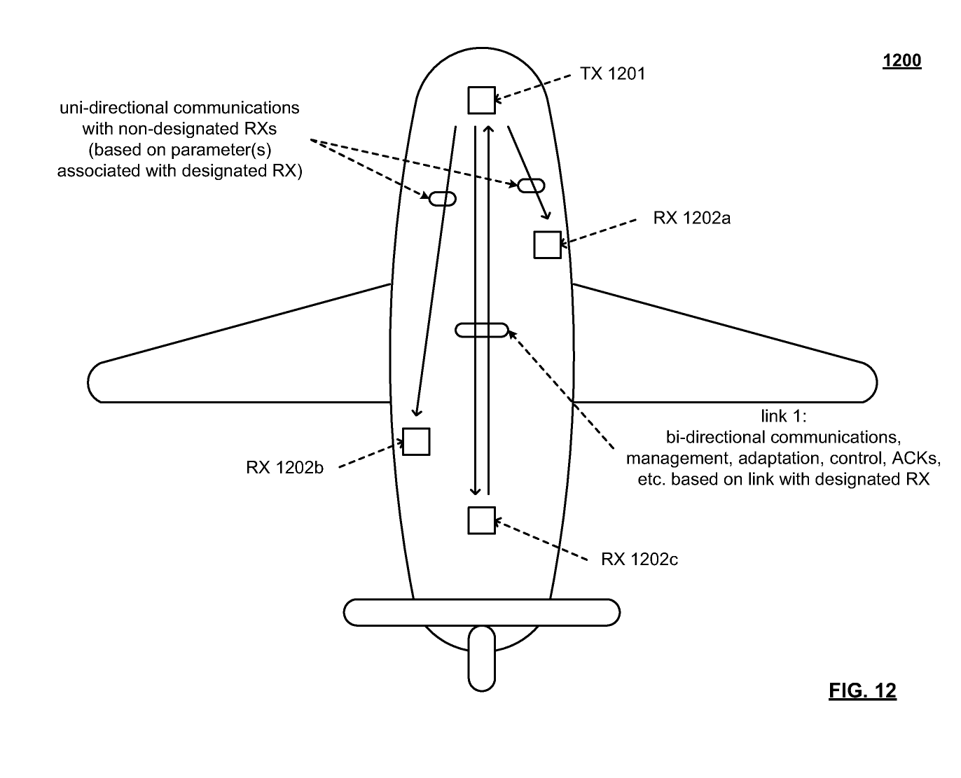

FIG. 10 is a diagram illustrating an embodiment 1000 of feedback from a number of receiver wireless communication devices to a transmitter wireless communication device. With respect to this diagram, it may be seen that feedback may be provided from various receiver wireless communication devices 1001a-1002c to a transmitter wireless communication device 1001. Such feedback is provided in accordance with any of a variety of manners including carrier sense multiple access/collision avoidance (CSMA/CA), scheduled access, providing one or more allotted periods of time [Δt(s)] for the respective receiver wireless communication devices 1001a-1002c, allowing for receiver selection, etc. Any of a variety of types of feedback may be provided for assistance, at least in part, for the transmitter wireless communication device 1001 to determine and/or select one or more operational parameters by which communications are effectuated there from to the receiver wireless communication devices 1002a-1002c and to retransmit packets that may have been lost during transmission.

In some embodiments, feedback may be provided from each respective receiver wireless communication device 1002a-1002c to a transmitter wireless communication device 1001. In other embodiments, such as those in which the receiver wireless communication devices 1002a-1002c are divided into respective groups, a selected one or more of the receiver wireless communication devices within each respective group may provide feedback to the transmitter wireless communication device 1001.

As may be seen with respect to this embodiment, bi-directional communications may be effectuated not only between a designated receiver wireless communication device 1002b and the transmitter wireless communication device 1001, but bi-directional communications may also be effectuated between those non-designated receiver wireless communication devices 1002a-1002c and the transmitter wireless communication device 1001. In some embodiments, consideration with respect to the designated receiver wireless communication device 1002b is given greater weight than consideration with respect to the non-designated receiver wireless communication devices 1002a-1002c.

With respect to this embodiment, it is noted that communications from the non-designated receiver wireless communication devices 1002a-1002c to the transmitter wireless communication device 1001 are effectuated in a manner so that contention and collisions are minimized or reduced (ideally, eliminated). In contrast to an embodiment in which only one of the receiver wireless communication devices supports bi-directional communications with the transmitter wireless communication device 1001, when multiple of the receiver wireless communication devices support bi-directional communications with the transmitter wireless communication device 1001, appropriate measures are taken so that contention and collisions between upstream and downstream communications are minimized or limited.

From certain perspectives and in certain embodiments, the upstream communications from the receiver wireless communication devices 1002a-1002c (e.g., including non-designated and designated) to the transmitter wireless communication device 1001 are made at a time or during a time interval that is between time 1 and time 2 of the previous embodiment. In some instances, an explicit request to transmit upstream data may be made from the transmitter wireless communication device to one of the receiver wireless communication devices. The particular manner by which such communications are effectuated may be pre-negotiated between those respective wireless communication devices. It is of course noted that feedback from the receiver wireless communication devices 1002a-1002c to the transmitter wireless communication device 1001 may be provided at different times. For example, a first group of feedback may be provided at or during a first time, a second group of feedback may be provided at or during a second time, etc.

Any of a number of conditions and/or constraints may be employed to trigger the providing of feedback from the receiver wireless communication devices 1002a-1002c to the transmitter wireless communication device 1001. For example, different feedback may be provided periodically after the elapse of certain periods of time (e.g., every X seconds, etc.). Alternatively, detection of certain conditions and/or the change of certain conditions may operate as a triggering event that initiates the providing of feedback from the receiver wireless communication devices 1002a-1002c to the transmitter wireless communication device 1001.

FIG. 11 is a diagram illustrating an embodiment 1100 of grouping of receiver wireless communication devices into respective groups and supporting of communications selectively with each respective group. As may be seen with respect to this diagram, a group of receiver wireless communication devices 1102a-1102f may be further subdivided into two or more respective groups. For example, as depicted within this diagram, a group 1 includes receiver wireless communication devices 1102a-1102b, a group 2 includes receiver wireless communication devices 1102c-1102d, and so on up to a group N includes receiver wireless communication devices 1102e-1102f.

Communications from the transmitter wireless communication device 1101 to each of the respective groups of receiver wireless communication devices may be performed selectively. That is to say, communications to the first group of receiver wireless communication devices may be performed differently than communications to the second group of receiver wireless communication devices. Within each respective group of receiver wireless communication devices, one receiver wireless communication device within that group may be designated as that receiver wireless communication device (and its respective communication link with transmitter wireless communication device 1101) which is employed to determine and/or select the one or more operational parameters by which communications are effectuated to all of the receiver wireless communication devices within that respective group of receiver wireless communication devices. Alternatively, in some embodiments, as also described elsewhere with respect to different diagrams and/or embodiments, a common set of parameters may be selected as being most appropriately suited for all or a subset of the receiver wireless communication devices within that respective group intending to receive the media delivery.

It is also noted that, within each respective group, different receiver wireless communication devices may be designated at different times. That is to say, the same receiver wireless communication device within a given group need not necessarily serve as that receiver wireless communication device (and its respective communication link with transmitter wireless communication device 1101) which is employed to determine and/or select the one or more operational parameters by which communications are effectuated to all of the receiver wireless communication devices within that respective group of receiver wireless communication devices.

Moreover, the grouping of all of the receiver wireless communication devices into respective groups need not necessarily be static. For example, a given group of receiver wireless communication devices may include a different group of receiver wireless communication devices at different times. Any of a number of conditions and/or constraints may be employed to trigger the grouping of the various receiver wireless communication devices. For example, the grouping of the various receiver wireless communication devices may be performed periodically after the elapse of certain periods of time (e.g., every X seconds, etc.). Alternatively, detection of certain conditions and/or the change of certain conditions may operate as a triggering event that initiates the grouping of the various receiver wireless communication devices.

In some embodiments, each of the respective groups of receiver wireless communication devices has an associated group address (e.g., at the IP layer). A given group address is used to indicate all of the receiver wireless communication devices within a particular group. When a receiver wireless communication device, that is associated with a given group address, receives a communication that indicates that given group address, then the receiver wireless communication device may then determine that the communication is intended for it. However, when that receiver wireless communication device receives a communication that indicates another group address (e.g., at the IP layer), that receiver wireless communication device may determine that the communication is not properly intended for it. In accordance with certain embodiments of point to multipoint wireless video communications, the group addressing may be effectuated in accordance with a relatively higher layer of the communication protocol (e.g., layer 2). While such wireless video communications are made in accordance with a multicast manner for downstream communications (e.g., from the TX to one or more RXs), the acknowledgments are made in accordance with a unicast manner for upstream communications (e.g., from one or more RXs to the TX). It is noted that certain periodic refreshers may be communicated downstream (e.g., from the TX to the RX(s)) to ensure that all of the receiver wireless communication devices are in synchronization. For example, an I-frame may be periodically provided in downstream communications (e.g., from the TX to the RX(s)) to ensure appropriate operation and to refresh the video frame (e.g., VSYNC). In some embodiments, different and respective I-frames may be provided within downstream communications on a regular basis (e.g., from the TX to the RX(s)) to ensure appropriate operation of the media delivery within the wireless video communication system.

An even other embodiments, it is noted that communications between the TX 1101 and all of the RXs within a given group may be handled in a bi-directional manner. That is to say, communications with each respective group of RXs need not be handled in exactly the same way (e.g., such that communications are unidirectional for all of the RXs of that group except for the designated RX in that group [for which communications are bi-directional]). As such, communications with different respective groups may be handled differently. In one embodiment, communications between the TX 1101 and all of the RXs within group 1 are handled in a bi-directional manner, while communications between the TX 1101 and the RXs in group 2 are handled such that communications are unidirectional for all of the RXs of that group except for the designated RX in that group [for which communications are bi-directional].

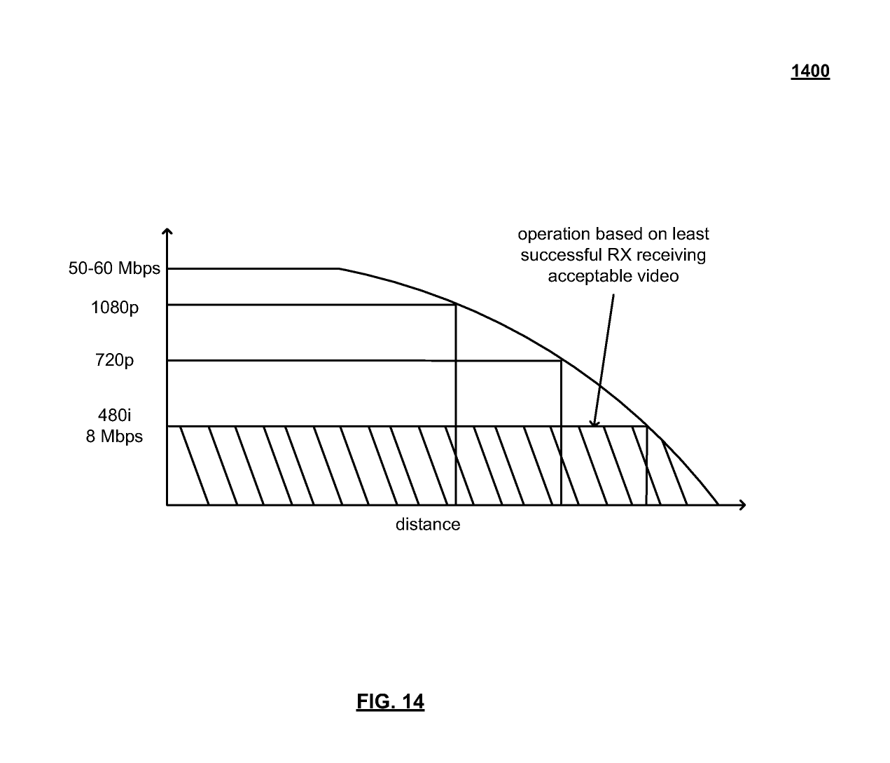

FIG. 12 is a diagram illustrating an embodiment 1200 of an aircraft application adapted for supporting communications from a transmitter wireless communication device to a number of receiver wireless communication devices. As the reader will understand with respect to the providing of communications from a transmitter wireless communication device to a number of receiver wireless communication devices, there are a variety of application contexts in which such communications may be effectuated.

One possible application context would include an airplane or aircraft type application. For example, such an application context maybe operative to support communications from a transmitter wireless communication device 1201 to a number of receiver wireless communication devices 1202a-1202c.

For example, in the context of communications including video information (e.g., streaming video), a transmitter wireless communication device 1201 is or is to provide the information to a number of receiver wireless communication devices 1202a-1202c. In one possible embodiment, a designated receiver wireless communication device 1202c may be a predetermined receiver wireless communication device located at a furthest proximity within the fixed structure of the aircraft. By determining and/or selecting one or more operational parameters based on the designated receiver wireless communication device 1202c, a reasonably high degree of confidence may be achieved such that all of the non-designated receiver wireless communication devices 1202a-1202c will be able to receive communications from the transmitter wireless communication device 1201 in an acceptable manner and with an acceptable quality of service.

In alternative embodiments, one of the receiver wireless communication devices 1202a-1202c is not predetermined as being the designated receiver wireless communication device. In such embodiments, any of the receiver wireless communication devices 1202a-1202c may be designated to operate as that particular receiver wireless communication device which is employed, at least in part, to determine and/or select the one or more operational parameters by which communications are effectuated to all of the receiver wireless communication devices 1202a-1202c. As the reader will understand with respect to such embodiments, at different times, different respective receiver wireless communication devices 1202a-1202c may serve as that particular wireless communication device which is employed, at least in part, to determine and/or select the one or more operational parameters by which communications are effectuated to all of the receiver wireless communication devices 1202a-1202c. Alternatively, as also described elsewhere with respect to different diagrams and/or embodiments, a common set of parameters may be selected as being most appropriately suited for all or a subset of the receiver wireless communication devices intending to receive the media delivery. For example, other various embodiments herein describe various conditions and/or constraints by which the selection of one of the receiver wireless communication devices may be made.

Regardless of the manner in which one of the receiver wireless communication devices is identified as the designated receiver wireless communication device, communications between the transmitter wireless communication device 1201 and that designated receiver wireless communication device are effectuated in accordance with bi-directional communications. Communications between the transmitter wireless communication device 1201 and all of the other non-designated receiver wireless communication devices are effectuated in accordance with unidirectional communications.

It is also noted that, while a particular embodiment of an aircraft is depicted with respect to this diagram, many other application contexts may be implemented in accordance with various aspects, and their equivalents, of the invention. Some examples of such application contexts include a coffee shop, a restaurant, an airport lounge, and/or any other such defined region or space in which multiple receiver wireless communication devices may be implemented or operative to receive communications from a common transmitter wireless communication device.

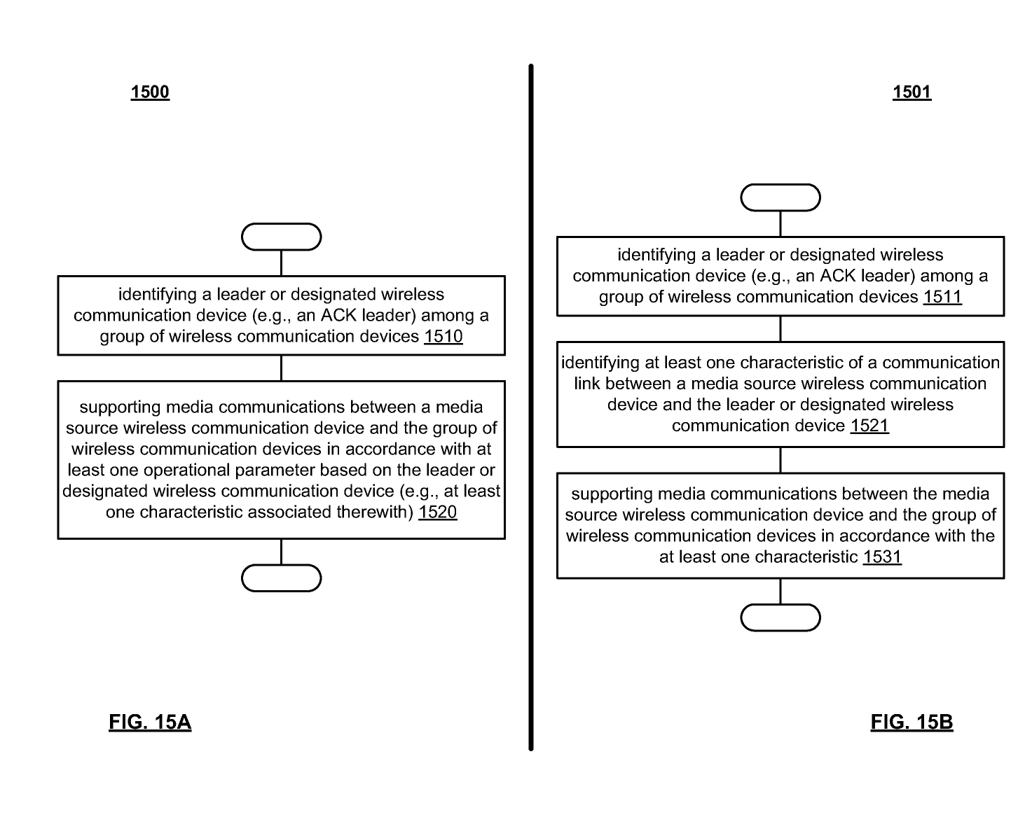

FIG. 13 is a diagram illustrating an embodiment 1300 of grouping of receiver wireless communication devices into respective groups and supporting communications thereto with respectively different operational parameter(s). As may be understood with respect to this embodiment, different receiver wireless communication devices are provided different respective communications in accordance with different respective operational parameter(s). This embodiment has some similarities to certain previous embodiments in which various receiver wireless communication devices are divided into various groups.

In this particular embodiment, the receiver wireless communication devices are divided into groups such that each of the respective wireless communication devices within a particular group is operative to support the receipt of communications in accordance with a given level of service, quality of service, etc. For example, in the context of communications including video information (e.g., streaming video), any of the respective receiver wireless communication devices is then operative to receive such video information from such a transmitter wireless communication device. Each of the receiver wireless communication devices 1302a-1302b is operative to receive such communications (e.g., video information) from transmitter wireless communication device 1301 in accordance with first one or more operational parameters. Each of the receiver wireless communication devices 1302c-1302d is operative to receive such communications (e.g., video information) from transmitter wireless communication device 1301 in accordance with second one or more operational parameters. Analogously, each of the receiver wireless communication devices 1302e-1302f is operative to receive such communications (e.g., video information) from transmitter wireless communication device 1301 in accordance with a third one or more operational parameters. Generally speaking, the receiver wireless communication devices may be divided into any desired number of groups such that those respective receiver wireless communication devices within each respective group are operative to receive communications (e.g., video information) from transmitter wireless communication device 1301 in accordance with respective one or more operational parameters.

As an example of video communications, each of the receiver wireless communication devices 1302a-1302b may be operative to receive such communications (e.g., video information) from transmitter wireless communication device 1301 in accordance with a first video signal quality and resolution (e.g., 1080i). Each of the receiver wireless communication devices 1302c-1302d may be operative to receive such communications (e.g., video information) from transmitter wireless communication device 1301 in accordance with a second video signal quality and resolution (e.g., 720p). Each of the receiver wireless communication devices 1302e-1302f may be operative to receive such communications (e.g., video information) from transmitter wireless communication device 1301 in accordance with a third video signal quality and resolution (e.g., 480i). For example, considering the respective concentric circles around the transmitter wireless communication device 1301, relatively higher signal quality and resolution may be provided to those receiver wireless communication devices that having an adequate signal to noise ratio (SNR) to support such a resolution (e.g., often times, though not always, those receiver wireless communication devices having an adequate SNR will be located relatively close or to the transmitter wireless communication device 1301). Those receiver wireless communication devices that respectively have relatively lower SNR/link quality indications (e.g., which may correspond to those receiver wireless communication devices being located respectively further from the transmitter wireless communication device 1301) may be provided successively and progressively relatively lower signal quality and resolution signals. Also, while concentric circles are employed within this diagram for ease of illustration, it is of course noted that such grouping of the receiver wireless communication devices may not be so uniformly made in certain embodiments. For example, any of a number of effects, including multipath, interference, distortion, etc. may lead to grouping of the receiver wireless communication devices in much different ways.

Generally speaking, the receiver wireless communication devices may be divided into any number of groups such that those respective receiver wireless communication devices within each respective group are operative to receive communications (e.g., video information) from transmitter wireless communication device 1301 in accordance with a respective video signal quality and resolution.

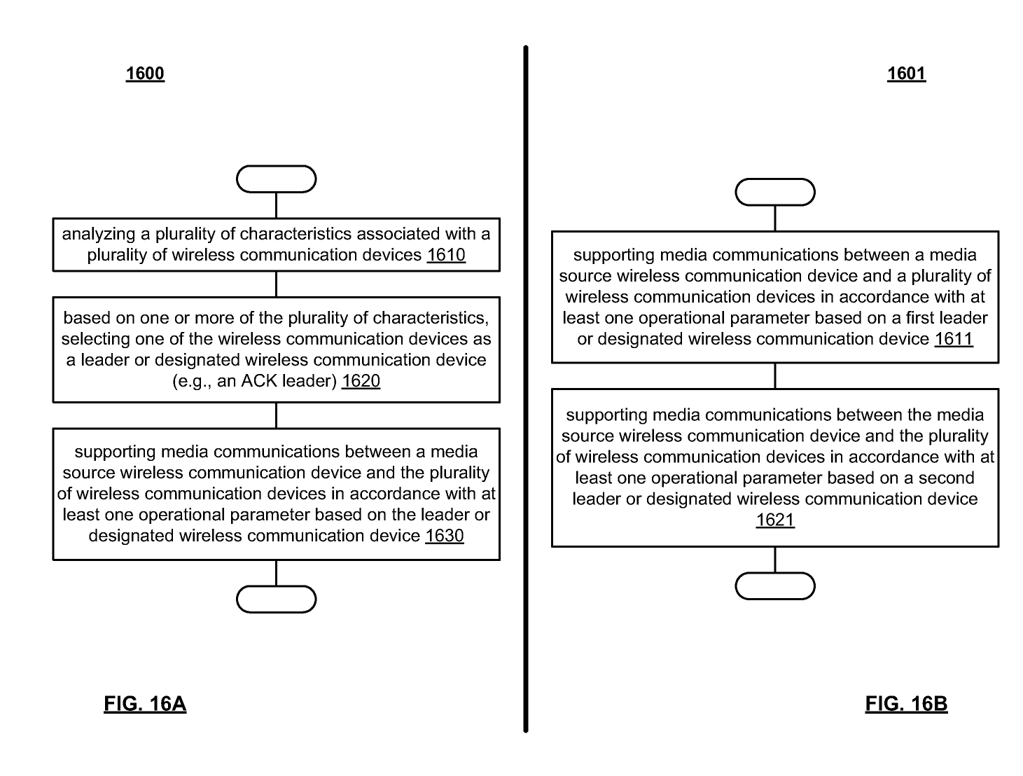

FIG. 14 is a diagram illustrating an embodiment 1400 depicting relationship between bit rate and range in accordance with supporting communications from a transmitter wireless communication device to a number of receiver wireless communication devices. With respect to this diagram, the vertical axis relates to bits per second and the horizontal axis relates to distance (e.g., from a transmitter wireless communication device to various receiver wireless communication devices). As the reader will understand with respect to video communications, a minimum bit rate per second may be required to effectuate acceptable quality media signaling (e.g., video signaling, audio signaling, etc.). For example, a minimum threshold of such bit rate per second may be selected as being approximately 8 Mega-bits per second (Mbps) to effectuate a signal quality and resolution of approximately 480p.

As can be seen with respect to this diagram, a minimum acceptable bit rate per second may be selected so that a sufficiently acceptable level of video delivery may be provided to all receiver wireless communication devices. For example, a least successful receiver wireless communication device may be chosen that still is operative to receive such a sufficiently acceptable level of video delivery. Such a receiver wireless communication device will then serve as the designated receiver wireless communication device (e.g., acknowledgment leader) among a group of receiver wireless communication devices. In certain embodiments, the selection of which the receiver wireless communication devices is to serve as this acknowledgment leader may be made in accordance with the constraint of a least successful receiver wireless communication device that is operative to receive delivery of video communications in accordance with a minimum acceptable quality (e.g., in accordance with such a constraint as indicated within the diagram). As may be seen, one or more additional constraints may be employed in selecting which receiver wireless communication device is going to serve as an acknowledgment leader.

Of course, the evaluation of which receiver wireless communication device will serve in this role may be made as a function of time and/or any other triggering condition as has been described with respect to other embodiments herein. As described with respect to other embodiments, the selection or reselection of which receiver wireless communication device will serve as the acknowledgment leader may be performed periodically. Such selection or reselection process may be based on one or more other considerations as well (e.g., selection of a new acknowledgment leader may be made when a large amount of feedback is received from those receiver wireless communication devices that are not serving as the acknowledgment leader).

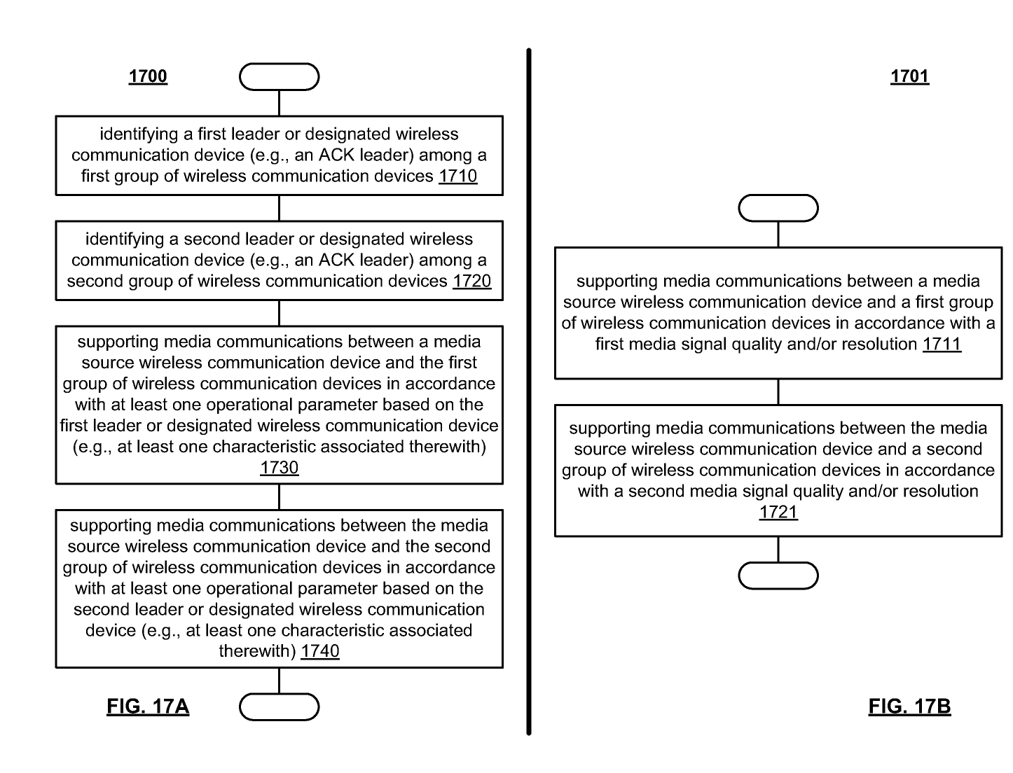

FIG. 15A, FIG. 15B, FIG. 16A, FIG. 16B, FIG. 17A, and FIG. 17B illustrate various embodiment of methods as may be performed in accordance with operation of various devices such as various wireless communication devices.

Referring to method 1500 of FIG. 15A, the method 1500 begins by identifying a leader or designated wireless communication device among a group of wireless communication devices, as shown in a block 1510. For example, in one possible embodiment and other certain embodiments described herein, the leader or designated wireless communication device serves as an acknowledgment (ACK) leader.

The method 1500 continues by supporting media communications between a media source wireless communication device and the group of wireless communication devices in accordance with at least one operational parameter based on the leader or designated wireless communication device, as shown in a block 1520. For example, the at least one parameter based on the leader or designated wireless communication device may correspond to any one or more characteristics associated with the leader or designated wireless communication device and/or a communication link between the media source wireless communication device and the leader or designated wireless communication device.

Referring to method 1501 of FIG. 15B, the method 1501 begins by identifying a leader or designated wireless communication device among a group of wireless communication devices, as shown in a block 1511. For example, in this embodiment and other certain embodiments described herein, the leader or designated wireless communication device may be an acknowledgment leader.

The method 1501 then operates by identifying at least one characteristic of a communication link between a media source wireless communication device and the leader or designated wireless communication device, as shown in a block 1521. The method 1501 continues by supporting media communications between the media source wireless communication device and the group of wireless communication device in accordance with the at least one characteristic, as shown in a block 1531.

Referring to method 1600 of FIG. 16A, the method 1600 begins by analyzing a plurality of characteristics associated with a plurality of wireless communication devices, as shown in a block 1610. The method 1600 continues by selecting one of the wireless communication devices as a leader or designated wireless communication device based on one or more of the plurality of characteristics, as shown in a block 1620. In one possible embodiment and other certain embodiments described herein, the leader or designated wireless communication device may be an acknowledgment (ACK) leader.

The method 1600 then operates by supporting media communications between a media source wireless communication device and the plurality of wireless communication devices in accordance with at least one operational parameter based on the leader or designated wireless communication device, as shown in a block 1630.

Referring to method 1601 of FIG. 16B, the method 1601 begins by supporting media communications between a media source wireless communication device and a plurality of wireless communication devices in accordance with at least one operational parameter based on a first leader or designated wireless communication device, as shown in a block 1611.

The method 1601 then operates by supporting media communications between the media source wireless communication device and the plurality of wireless communication devices in accordance with at least one operational parameter based on a second leader or designated wireless communication device, as shown in a block 1621.

As the reader will understand, different respective wireless communication devices may be designated as the leader or designated wireless communication device at different times.

Referring to method 1700 of FIG. 17A, the method 1700 begins by identifying a first leader or designated wireless communication device among a first group of wireless communication devices, as shown in a block 1710.

The method 1700 continues by identifying a second leader or designated wireless communication device among a second group of wireless communication devices, as shown in a block 1720.

The method 1700 then operates by supporting media communications between a media source wireless communication device and the first group of wireless communication devices in accordance with at least one operational parameter based on the first leader or designated wireless communication device, as shown in a block 1730.

The method 1700 continues by supporting media communications between the media source wireless communication device and the second group of wireless communication devices in accordance with at least one operational parameter based on the second leader or designated wireless communication device, as shown in a block 1740.

As the reader will understand, a given media source wireless communication device may support respective media communications with two or more different groups of wireless communication devices. Within each respective group, a respective leader or designated wireless communication device may be at identified therein. The respective leader or designated wireless communication device within a given group is that wireless communication device and at least one associated characteristic by which the media communications are supported.

Referring to method 1701 of FIG. 17B, the method 1701 begins by supporting media communications between a media source wireless communication device and a first group of wireless communication devices in accordance with a first media signal quality and/or resolution, as shown in a block 1711.

The method 1701 then operates by supporting media communications between the media source wireless communication device and a second group of wireless communication devices in accordance with a second media signal quality and/or resolution, as shown in a block 1721.

As the reader will understand, a given media source wireless communication device may support respective media communications with two or more different groups of wireless communication devices, and specifically, in accordance with different respective media signal qualities and/or resolutions.

It is also noted that the various operations and functions as described with respect to various methods herein may be performed within a wireless communication device, such as using a baseband processing module implemented therein (e.g., such as in accordance with the baseband processing module as described with reference to FIG. 2) and/or other components therein. For example, such a baseband processing module can perform various operations and/or processes (e.g., identification of the leader wire wireless communication device, analysis of various characteristics associated with various wireless communication devices and respective communication links, adaptive selection of different wireless communication devices to serve as leader at different times, etc.) in accordance with various aspects of the invention, and/or any other operations and functions as described herein, etc. or their respective equivalents.

It is noted that the various modules and/or circuitries (baseband processing modules and/or circuitries, encoding modules and/or circuitries, decoding modules and/or circuitries, etc., etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory (ROM), random access memory (RAM), volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

It is also noted that any of the connections or couplings between the various modules, circuits, functional blocks, components, devices, etc. within any of the various diagrams or as described herein may be differently implemented in different embodiments. For example, in one embodiment, such connections or couplings may be direct connections or direct couplings there between. In another embodiment, such connections or couplings may be indirect connections or indirect couplings there between (e.g., with one or more intervening components there between). Of course, certain other embodiments may have some combinations of such connections or couplings therein such that some of the connections or couplings are direct, while others are indirect. Different implementations may be employed for effectuating communicative coupling between modules, circuits, functional blocks, components, devices, etc. without departing from the scope and spirit of the invention.

Various aspects of the present invention have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Various aspects of the present invention have been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, various aspects of the present invention are not limited to such embodiments. It will be obvious to one of average skill in the art that various changes and modifications may be practiced within the spirit and scope of the invention, as limited only by the scope of the appended claims.

### Mode Selection Tables:

TABLE 1
2.4 GHz, 20/22 MHz channel BW, 54 Mbps max bit rate

| | | Code | | | | | | | |
|---|---|---|---|---|---|---|---|---|---|
| Rate | Modulation | Rate | NBPSC | NCBPS | NDBPS | EVM | Sensitivity | ACR | AACR |
| | Barker | | | | | | | | |
| 1 | BPSK | | | | | | | | |
| | Barker | | | | | | | | |
| 2 | QPSK | | | | | | | | |
| 5.5 | CCK | | | | | | | | |
| 6 | BPSK | 0.5 | 1 | 48 | 24 | −5 | −82 | 16 | 32 |
| 9 | BPSK | 0.75 | 1 | 48 | 36 | −8 | −81 | 15 | 31 |
| 11 | CCK | | | | | | | | |
| 12 | QPSK | 0.5 | 2 | 96 | 48 | −10 | −79 | 13 | 29 |
| 18 | QPSK | 0.75 | 2 | 96 | 72 | −13 | −77 | 11 | 27 |
| 24 | 16-QAM | 0.5 | 4 | 192 | 96 | −16 | −74 | 8 | 24 |
| 36 | 16-QAM | 0.75 | 4 | 192 | 144 | −19 | −70 | 4 | 20 |
| 48 | 64-QAM | 0.666 | 6 | 288 | 192 | −22 | −66 | 0 | 16 |
| 54 | 64-QAM | 0.75 | 6 | 288 | 216 | −25 | −65 | −1 | 15 |

TABLE 2
Channelization for Table 1

| | Frequency |
|---|---|
| Channel | (MHz) |
| 1 | 2412 |
| 2 | 2417 |
| 3 | 2422 |
| 4 | 2427 |
| 5 | 2432 |
| 6 | 2437 |
| 7 | 2442 |
| 8 | 2447 |
| 9 | 2452 |
| 10 | 2457 |
| 11 | 2462 |
| 12 | 2467 |

TABLE 3
Power Spectral Density (PSD) Mask for Table 1
PSD Mask 1

| Frequency Offset | dBr |
|---|---|
| −9 MHz to 9 MHz | 0 |
| +/−11 MHz | −20 |
| +/−20 MHz | −28 |
| +/−30 MHz and | −50 |
| greater | |

TABLE 4
5 GHz, 20 MHz channel BW, 54 Mbps max bit rate

| | | Code | | | | | | | |
|---|---|---|---|---|---|---|---|---|---|
| Rate | Modulation | Rate | NBPSC | NCBPS | NDBPS | EVM | Sensitivity | ACR | AACR |
| 6 | BPSK | 0.5 | 1 | 48 | 24 | −5 | −82 | 16 | 32 |
| 9 | BPSK | 0.75 | 1 | 48 | 36 | −8 | −81 | 15 | 31 |
| 12 | QPSK | 0.5 | 2 | 96 | 48 | −10 | −79 | 13 | 29 |
| 18 | QPSK | 0.75 | 2 | 96 | 72 | −13 | −77 | 11 | 27 |
| 24 | 16-QAM | 0.5 | 4 | 192 | 96 | −16 | −74 | 8 | 24 |
| 36 | 16-QAM | 0.75 | 4 | 192 | 144 | −19 | −70 | 4 | 20 |
| 48 | 64-QAM | 0.666 | 6 | 288 | 192 | −22 | −66 | 0 | 16 |
| 54 | 64-QAM | 0.75 | 6 | 288 | 216 | −25 | −65 | −1 | 15 |

TABLE 5
Channelization for Table 4

| | Frequency | | | Frequency | |
|---|---|---|---|---|---|
| Channel | (MHz) | Country | Channel | (MHz) | Country |
| 240 | 4920 | Japan | | | |
| 244 | 4940 | Japan | | | |
| 248 | 4960 | Japan | | | |
| 252 | 4980 | Japan | | | |
| 8 | 5040 | Japan | | | |
| 12 | 5060 | Japan | | | |
| 16 | 5080 | Japan | | | |
| 36 | 5180 | USA/Europe | 34 | 5170 | Japan |
| 40 | 5200 | USA/Europe | 38 | 5190 | Japan |
| 44 | 5220 | USA/Europe | 42 | 5210 | Japan |
| 48 | 5240 | USA/Europe | 46 | 5230 | Japan |
| 52 | 5260 | USA/Europe | | | |
| 56 | 5280 | USA/Europe | | | |
| 60 | 5300 | USA/Europe | | | |
| 64 | 5320 | USA/Europe | | | |
| 100 | 5500 | USA/Europe | | | |
| 104 | 5520 | USA/Europe | | | |
| 108 | 5540 | USA/Europe | | | |
| 112 | 5560 | USA/Europe | | | |
| 116 | 5580 | USA/Europe | | | |
| 120 | 5600 | USA/Europe | | | |
| 124 | 5620 | USA/Europe | | | |
| 128 | 5640 | USA/Europe | | | |
| 132 | 5660 | USA/Europe | | | |
| 136 | 5680 | USA/Europe | | | |
| 140 | 5700 | USA/Europe | | | |
| 149 | 5745 | USA | | | |
| 153 | 5765 | USA | | | |
| 157 | 5785 | USA | | | |
| 161 | 5805 | USA | | | |
| 165 | 5825 | USA | | | |

TABLE 6
2.4 GHz, 20 MHz channel BW, 192 Mbps max bit rate

| | | ST | | | | | |
|---|---|---|---|---|---|---|---|
| | TX | Code | Mod- | Code | | | |
| Rate | Antennas | Rate | ulation | Rate | NBPSC | NCBPS | NDBPS |
| 12 | 2 | 1 | BPSK | 0.5 | 1 | 48 | 24 |
| 24 | 2 | 1 | QPSK | 0.5 | 2 | 96 | 48 |
| 48 | 2 | 1 | 16-QAM | 0.5 | 4 | 192 | 96 |
| 96 | 2 | 1 | 64-QAM | 0.666 | 6 | 288 | 192 |
| 108 | 2 | 1 | 64-QAM | 0.75 | 6 | 288 | 216 |
| 18 | 3 | 1 | BPSK | 0.5 | 1 | 48 | 24 |
| 36 | 3 | 1 | QPSK | 0.5 | 2 | 96 | 48 |
| 72 | 3 | 1 | 16-QAM | 0.5 | 4 | 192 | 96 |
| 144 | 3 | 1 | 64-QAM | 0.666 | 6 | 288 | 192 |
| 162 | 3 | 1 | 64-QAM | 0.75 | 6 | 288 | 216 |
| 24 | 4 | 1 | BPSK | 0.5 | 1 | 48 | 24 |
| 48 | 4 | 1 | QPSK | 0.5 | 2 | 96 | 48 |
| 96 | 4 | 1 | 16-QAM | 0.5 | 4 | 192 | 96 |
| 192 | 4 | 1 | 64-QAM | 0.666 | 6 | 288 | 192 |
| 216 | 4 | 1 | 64-QAM | 0.75 | 6 | 288 | 216 |

TABLE 7
Channelization for Table 6

| Channel | Frequency (MHz) |
|---|---|
| 1 | 2412 |
| 2 | 2417 |
| 3 | 2422 |
| 4 | 2427 |
| 5 | 2432 |
| 6 | 2437 |
| 7 | 2442 |
| 8 | 2447 |
| 9 | 2452 |
| 10 | 2457 |
| 11 | 2462 |
| 12 | 2467 |

TABLE 8
5 GHz, 20 MHz channel BW, 192 Mbps max bit rate

| | | ST | | | | | |
|---|---|---|---|---|---|---|---|
| | TX | Code | Mod- | Code | | | |
| Rate | Antennas | Rate | ulation | Rate | NBPSC | NCBPS | NDBPS |
| 12 | 2 | 1 | BPSK | 0.5 | 1 | 48 | 24 |
| 24 | 2 | 1 | QPSK | 0.5 | 2 | 96 | 48 |
| 48 | 2 | 1 | 16-QAM | 0.5 | 4 | 192 | 96 |
| 96 | 2 | 1 | 64-QAM | 0.666 | 6 | 288 | 192 |
| 108 | 2 | 1 | 64-QAM | 0.75 | 6 | 288 | 216 |
| 18 | 3 | 1 | BPSK | 0.5 | 1 | 48 | 24 |
| 36 | 3 | 1 | QPSK | 0.5 | 2 | 96 | 48 |
| 72 | 3 | 1 | 16-QAM | 0.5 | 4 | 192 | 96 |
| 144 | 3 | 1 | 64-QAM | 0.666 | 6 | 288 | 192 |
| 162 | 3 | 1 | 64-QAM | 0.75 | 6 | 288 | 216 |
| 24 | 4 | 1 | BPSK | 0.5 | 1 | 48 | 24 |
| 48 | 4 | 1 | QPSK | 0.5 | 2 | 96 | 48 |
| 96 | 4 | 1 | 16-QAM | 0.5 | 4 | 192 | 96 |
| 192 | 4 | 1 | 64-QAM | 0.666 | 6 | 288 | 192 |
| 216 | 4 | 1 | 64-QAM | 0.75 | 6 | 288 | 216 |

TABLE 9
channelization for Table 8

| | Frequency | | | Frequency | |
|---|---|---|---|---|---|
| Channel | (MHz) | Country | Channel | (MHz) | Country |
| 240 | 4920 | Japan | | | |
| 244 | 4940 | Japan | | | |
| 248 | 4960 | Japan | | | |
| 252 | 4980 | Japan | | | |
| 8 | 5040 | Japan | | | |
| 12 | 5060 | Japan | | | |
| 16 | 5080 | Japan | | | |
| 36 | 5180 | USA/Europe | 34 | 5170 | Japan |
| 40 | 5200 | USA/Europe | 38 | 5190 | Japan |
| 44 | 5220 | USA/Europe | 42 | 5210 | Japan |
| 48 | 5240 | USA/Europe | 46 | 5230 | Japan |
| 52 | 5260 | USA/Europe | | | |
| 56 | 5280 | USA/Europe | | | |
| 60 | 5300 | USA/Europe | | | |
| 64 | 5320 | USA/Europe | | | |
| 100 | 5500 | USA/Europe | | | |
| 104 | 5520 | USA/Europe | | | |
| 108 | 5540 | USA/Europe | | | |
| 112 | 5560 | USA/Europe | | | |
| 116 | 5580 | USA/Europe | | | |
| 120 | 5600 | USA/Europe | | | |
| 124 | 5620 | USA/Europe | | | |
| 128 | 5640 | USA/Europe | | | |
| 132 | 5660 | USA/Europe | | | |
| 136 | 5680 | USA/Europe | | | |
| 140 | 5700 | USA/Europe | | | |
| 149 | 5745 | USA | | | |
| 153 | 5765 | USA | | | |
| 157 | 5785 | USA | | | |
| 161 | 5805 | USA | | | |
| 165 | 5825 | USA | | | |

TABLE 10
5 GHz, with 40 MHz channels and max bit rate of 486 Mbps

| | TX | ST Code | | Code | |
|---|---|---|---|---|---|
| Rate | Antennas | Rate | Modulation | Rate | NBPSC |
| 13.5 Mbps | 1 | 1 | BPSK | 0.5 | 1 |
| 27 Mbps | 1 | 1 | QPSK | 0.5 | 2 |
| 54 Mbps | 1 | 1 | 16-QAM | 0.5 | 4 |
| 108 Mbps | 1 | 1 | 64-QAM | 0.666 | 6 |
| 121.5 Mbps | 1 | 1 | 64-QAM | 0.75 | 6 |
| 27 Mbps | 2 | 1 | BPSK | 0.5 | 1 |
| 54 Mbps | 2 | 1 | QPSK | 0.5 | 2 |
| 108 Mbps | 2 | 1 | 16-QAM | 0.5 | 4 |
| 216 Mbps | 2 | 1 | 64-QAM | 0.666 | 6 |
| 243 Mbps | 2 | 1 | 64-QAM | 0.75 | 6 |
| 40.5 Mbps | 3 | 1 | BPSK | 0.5 | 1 |
| 81 Mbps | 3 | 1 | QPSK | 0.5 | 2 |
| 162 Mbps | 3 | 1 | 16-QAM | 0.5 | 4 |
| 324 Mbps | 3 | 1 | 64-QAM | 0.666 | 6 |
| 365.5 Mbps | 3 | 1 | 64-QAM | 0.75 | 6 |
| 54 Mbps | 4 | 1 | BPSK | 0.5 | 1 |
| 108 Mbps | 4 | 1 | QPSK | 0.5 | 2 |
| 216 Mbps | 4 | 1 | 16-QAM | 0.5 | 4 |
| 432 Mbps | 4 | 1 | 64-QAM | 0.666 | 6 |
| 486 Mbps | 4 | 1 | 64-QAM | 0.75 | 6 |

TABLE 11
Power Spectral Density (PSD) mask for Table 10
PSD Mask 2

| Frequency Offset | dBr |
|---|---|
| −19 MHz to 19 MHz | 0 |
| +/−21 MHz | −20 |
| +/−30 MHz | −28 |
| +/−40 MHz and | −50 |
| greater | |

TABLE 12
Channelization for Table 10

| | Frequency | | | Frequency | |
|---|---|---|---|---|---|
| Channel | (MHz) | Country | Channel | (MHz) | County |
| 242 | 4930 | Japan | | | |
| 250 | 4970 | Japan | | | |
| 12 | 5060 | Japan | | | |
| 38 | 5190 | USA/Europe | 36 | 5180 | Japan |
| 46 | 5230 | USA/Europe | 44 | 5520 | Japan |
| 54 | 5270 | USA/Europe | | | |
| 62 | 5310 | USA/Europe | | | |
| 102 | 5510 | USA/Europe | | | |
| 110 | 5550 | USA/Europe | | | |
| 118 | 5590 | USA/Europe | | | |
| 126 | 5630 | USA/Europe | | | |
| 134 | 5670 | USA/Europe | | | |
| 151 | 5755 | USA | | | |
| 159 | 5795 | USA | | | |

What is claimed is:

1. An apparatus, comprising:
a processing module for:
identifying a first designated wireless communication device among a plurality of wireless communication devices based on a plurality of characteristics associated with delivering media from the apparatus to the plurality of wireless communication devices or a subset thereof; and
identifying at least one operational parameter associated with the delivering media from the apparatus to the plurality of wireless communication devices or the subset thereof; and
at least one radio for supporting media communications with the plurality of wireless communication devices or the subset thereof in accordance with the at least one operational parameter and in accordance with modified multi-casting including supporting bi-directional communications with the first designated wireless communication device; and wherein:
based on change of at least one of the plurality of characteristics beyond at least one of a plurality of thresholds:
a second designated wireless communication device being identified among the plurality of wireless communication devices; and
the at least one radio for supporting media communications with the plurality of wireless communication devices or the subset thereof in accordance with modified multi-casting including supporting bi-directional communications with the second designated wireless communication device.

2. The apparatus of claim 1, wherein plurality of characteristics associated with delivering media from the apparatus to the plurality of wireless communication devices or the subset thereof including:
respective abilities of the plurality of wireless communication devices for receiving communications from the apparatus;
respective abilities of the plurality of wireless communication devices for supporting communications with other of the plurality of wireless communication devices;
respective abilities of the plurality of wireless communication devices for resending communications received from the apparatus to other of the plurality of wireless communication devices;
respective user usage information of the plurality of wireless communication devices;
respective communication capabilities of the plurality of wireless communication devices;
respective communication histories of the plurality of wireless communication devices;
respective energy constraints of the plurality of wireless communication devices;
respective acknowledgement (ACK) histories of the plurality of wireless communication devices, and
respective negative acknowledgement (N-ACK) histories of the plurality of wireless communication devices.

3. The apparatus of claim 1, wherein plurality of characteristics associated with delivering media from the apparatus to the plurality of wireless communication devices or the subset thereof including at least one of:
respective abilities of the plurality of wireless communication devices or the subset thereof for receiving communications from the apparatus;
respective abilities of the plurality of wireless communication devices or the subset thereof for supporting communications with other of the plurality of wireless communication devices;
respective abilities of the plurality of wireless communication devices or the subset thereof for resending communications received from the apparatus to other of the plurality of wireless communication devices;
respective user usage information of the plurality of wireless communication devices or the subset thereof;
respective communication capabilities of the plurality of wireless communication devices or the subset thereof;
respective communication histories of the plurality of wireless communication devices or the subset thereof;
respective energy constraints of the plurality of wireless communication devices or the subset thereof;
respective acknowledgement (ACK) histories of the plurality of wireless communication devices or the subset thereof, and
respective negative acknowledgement (N-ACK) histories of the plurality of wireless communication devices or the subset thereof.

4. The apparatus of claim 1, wherein:
the processing module for identifying the first designated wireless communication device or the second designated wireless communication device among the plurality of wireless communication devices based at least one of:
ability of the first designated wireless communication device or the second designated wireless communication device for receiving communications from the apparatus;
ability of the first designated wireless communication device or the second designated wireless communication device for supporting communications with other of the plurality of wireless communication devices or the subset thereof;
ability of the first designated wireless communication device or the second designated wireless communication device for resending communications received from the apparatus to at least one other of the plurality of wireless communication devices;
user usage information of the first designated wireless communication device or the second designated wireless communication device;
communication capability of the first designated wireless communication device or the second designated wireless communication device;
communication history of the first designated wireless communication device or the second designated wireless communication device;
energy constraint of the first designated wireless communication device or the second designated wireless communication device;
acknowledgement (ACK) history of the first designated wireless communication device or the second designated wireless communication device, and
negative acknowledgement (N-ACK) history of the first designated wireless communication device or the second designated wireless communication device.

5. The apparatus of claim 1, wherein:
the plurality of characteristics associated with delivering media from the apparatus to the plurality of wireless communication devices or the subset thereof including:
respective latencies associated with delivering media from the apparatus to each respective one of the plurality of wireless communication devices or the subset thereof;
respective video qualities associated with delivering media from the apparatus to each respective one of the plurality of wireless communication devices or the subset thereof; and
respective bandwidth requirements associated with delivering media from the apparatus to each respective one of the plurality of wireless communication devices or the subset thereof.

6. The apparatus of claim 1, wherein:
the apparatus being an access point (AP); and
the plurality of wireless communication devices being a plurality of wireless stations (STAs).

7. An apparatus, comprising:
a processing module for:
identifying a designated wireless communication device among a plurality of wireless communication devices based on a plurality of characteristics associated with delivering media from the apparatus to the plurality of wireless communication devices or a subset thereof; and
identifying at least one operational parameter associated with the delivering media from the apparatus to the plurality of wireless communication devices or the subset thereof; and
at least one radio for delivering media to the plurality of wireless communication devices or the subset thereof in accordance with the at least one operational parameter and in accordance with modified multi-casting including supporting bi-directional communications with the designated wireless communication device.

8. The apparatus of claim 7, wherein the plurality of characteristics associated with delivering media from the apparatus to the plurality of wireless communication devices or the subset thereof including:
respective abilities of the plurality of wireless communication devices for receiving communications from the apparatus;
respective abilities of the plurality of wireless communication devices for supporting communications with other of the plurality of wireless communication devices;
respective abilities of the plurality of wireless communication devices for resending communications received from the apparatus to other of the plurality of wireless communication devices;
respective user usage information of the plurality of wireless communication devices;
respective communication capabilities of the plurality of wireless communication devices;
respective communication histories of the plurality of wireless communication devices;
respective energy constraints of the plurality of wireless communication devices;
respective acknowledgement (ACK) histories of the plurality of wireless communication devices, and
respective negative acknowledgement (N-ACK) histories of the plurality of wireless communication devices.

9. The apparatus of claim 7, wherein the plurality of characteristics associated with delivering media from the apparatus to the plurality of wireless communication devices or the subset thereof including at least one of:
respective abilities of the plurality of wireless communication devices or the subset thereof for receiving communications from the apparatus;
respective abilities of the plurality of wireless communication devices or the subset thereof for supporting communications with other of the plurality of wireless communication devices;
respective abilities of the plurality of wireless communication devices or the subset thereof for resending communications received from the apparatus to other of the plurality of wireless communication devices;
respective user usage information of the plurality of wireless communication devices or the subset thereof;
respective communication capabilities of the plurality of wireless communication devices or the subset thereof;
respective communication histories of the plurality of wireless communication devices or the subset thereof;
respective energy constraints of the plurality of wireless communication devices or the subset thereof;
respective acknowledgement (ACK) histories of the plurality of wireless communication devices or the subset thereof, and
respective negative acknowledgement (N-ACK) histories of the plurality of wireless communication devices or the subset thereof.

10. The apparatus of claim 7, wherein:
the processing module for identifying the designated wireless communication device among the plurality of wireless communication devices based at least one of:
ability of the designated wireless communication device for receiving communications from the apparatus;
ability of the designated wireless communication device for supporting communications with other of the plurality of wireless communication devices or the subset thereof;
ability of the designated wireless communication device for resending communications received from the apparatus to at least one other of the plurality of wireless communication devices;
user usage information of the designated wireless communication device;
communication capability of the designated wireless communication device;
communication history of the designated wireless communication device;
energy constraint of the designated wireless communication device;
acknowledgement (ACK) history of the designated wireless communication device, and
negative acknowledgement (N-ACK) history of the designated wireless communication device.

11. The apparatus of claim 7, wherein:
the plurality of characteristics associated with delivering media from the apparatus to the plurality of wireless communication devices or the subset thereof including:
respective latencies associated with delivering media from the apparatus to each respective one of the plurality of wireless communication devices or the subset thereof;
respective video qualities associated with delivering media from the apparatus to each respective one of the plurality of wireless communication devices or the subset thereof; and
respective bandwidth requirements associated with delivering media from the apparatus to each respective one of the plurality of wireless communication devices or the subset thereof.

12. The apparatus of claim 7, wherein:
based on change of at least one of the plurality of characteristics beyond at least one of a plurality of thresholds, the processing module for identifying at least one additional designated wireless communication device among the plurality of wireless communication devices; and
at least one radio for delivering the media to the plurality of wireless communication devices, the subset thereof, or at least one additional subset thereof, in accordance with modified multi-casting including supporting bi-directional communications with at least one additional designated wireless communication device.

13. The apparatus of claim 7, wherein:
the processing module for identifying a plurality of groups among the plurality of wireless communication devices;
the designated wireless communication device being among a first of the plurality of groups based on a plurality of characteristics associated with delivering media from the apparatus to the first of the plurality of groups;
the processing module for identifying at least one additional designated wireless communication device among a second of the plurality of groups based on a plurality of characteristics associated with delivering media from the apparatus to the second of the plurality of groups;
at least one radio for delivering media supporting the media communications with the first of the plurality of groups in accordance with the at least one operational parameter and in accordance with modified multi-casting including supporting bi-directional communications with the designated wireless communication device; and
at least one radio for delivering media supporting the media communications with the first of the plurality of groups in accordance with the at least one operational parameter and in accordance with modified multi-casting including supporting bi-directional communications with the at least one additional designated wireless communication device.

14. The apparatus of claim 7, wherein:
the processing module for identifying a plurality of groups among the plurality of wireless communication devices;
the at least one radio for delivering media supporting the media communications with a first of the plurality of groups in accordance with a first signal quality and resolution; and
the at least one radio for delivering media supporting at least one additional media communications with a second of the plurality of groups in accordance with a second signal quality and resolution.

15. The apparatus of claim 7, wherein:
the apparatus being an access point (AP); and
the plurality of wireless communication devices being a plurality of wireless stations (STAs).

16. A method for operating a first wireless communication device, the method comprising:
identifying a designated wireless communication device among a plurality of wireless communication devices based on a plurality of characteristics associated with delivering media from the first wireless communication device to the plurality of wireless communication devices or a subset thereof;
identifying at least one operational parameter associated with the delivering media from the first wireless communication device to the plurality of wireless communication devices or the subset thereof; and
delivering media to the plurality of wireless communication devices or the subset thereof in accordance with the at least one operational parameter and in accordance with modified multi-casting including supporting bi-directional communications with the designated wireless communication device.

17. The method of claim 16, wherein the plurality of characteristics associated with delivering media from the first wireless communication device to the plurality of wireless communication devices or the subset thereof including:
respective abilities of the plurality of wireless communication devices for receiving communications from the first wireless communication device;
respective abilities of the plurality of wireless communication devices for supporting communications with other of the plurality of wireless communication devices;
respective abilities of the plurality of wireless communication devices for resending communications received from the first wireless communication device to other of the plurality of wireless communication devices;
respective user usage information of the plurality of wireless communication devices;
respective communication capabilities of the plurality of wireless communication devices;
respective communication histories of the plurality of wireless communication devices;
respective energy constraints of the plurality of wireless communication devices;
respective acknowledgement (ACK) histories of the plurality of wireless communication devices, and
respective negative acknowledgement (N-ACK) histories of the plurality of wireless communication devices.

18. The method of claim 16, wherein the plurality of characteristics associated with delivering media from the first wireless communication device to the plurality of wireless communication devices or the subset thereof including at least one of:
respective abilities of the plurality of wireless communication devices or the subset thereof for receiving communications from the first wireless communication device;
respective abilities of the plurality of wireless communication devices or the subset thereof for supporting communications with other of the plurality of wireless communication devices;
respective abilities of the plurality of wireless communication devices or the subset thereof for resending communications received from the first wireless communication device to other of the plurality of wireless communication devices;
respective user usage information of the plurality of wireless communication devices or the subset thereof;
respective communication capabilities of the plurality of wireless communication devices or the subset thereof;
respective communication histories of the plurality of wireless communication devices or the subset thereof;
respective energy constraints of the plurality of wireless communication devices or the subset thereof;
respective acknowledgement (ACK) histories of the plurality of wireless communication devices or the subset thereof, and
respective negative acknowledgement (N-ACK) histories of the plurality of wireless communication devices or the subset thereof.

19. The method of claim 16, further comprising:
identifying the designated wireless communication device among the plurality of wireless communication devices based at least one of:
ability of the designated wireless communication device for receiving communications from the first wireless communication device;
ability of the designated wireless communication device for supporting communications with other of the plurality of wireless communication devices or the subset thereof;
ability of the designated wireless communication device for resending communications received from the first wireless communication device to at least one other of the plurality of wireless communication devices;
user usage information of the designated wireless communication device;
communication capability of the designated wireless communication device;
communication history of the designated wireless communication device;
energy constraint of the designated wireless communication device;
acknowledgement (ACK) history of the designated wireless communication device, and
negative acknowledgement (N-ACK) history of the designated wireless communication device.

20. The method of claim 16, wherein:
the plurality of characteristics associated with delivering media from the first wireless communication device to the plurality of wireless communication devices or the subset thereof including:
respective latencies associated with delivering media from the first wireless communication device to each respective one of the plurality of wireless communication devices or the subset thereof;
respective video qualities associated with delivering media from the first wireless communication device to each respective one of the plurality of wireless communication devices or the subset thereof; and
respective bandwidth requirements associated with delivering media from the first wireless communication device to each respective one of the plurality of wireless communication devices or the subset thereof.

21. The method of claim 16, further comprising:
based on change of at least one of the plurality of characteristics beyond at least one of a plurality of thresholds, identifying at least one additional designated wireless communication device among the plurality of wireless communication devices; and
delivering the media to the plurality of wireless communication devices, the subset thereof, or at least one additional subset thereof, in accordance with modified multi-casting including supporting bi-directional communications with at least one additional designated wireless communication device.

22. The method of claim 16, further comprising:
identifying a plurality of groups among the plurality of wireless communication devices, wherein the designated wireless communication device being among a first of the plurality of groups based on a plurality of characteristics associated with delivering media from the first wireless communication device to the first of the plurality of groups;
identifying at least one additional designated wireless communication device among a second of the plurality of groups based on a plurality of characteristics associated with delivering media from the first wireless communication device to the second of the plurality of groups;
delivering media supporting the media communications with the first of the plurality of groups in accordance with the at least one operational parameter and in accordance with modified multi-casting including supporting bi-directional communications with the designated wireless communication device; and
delivering media supporting the media communications with the first of the plurality of groups in accordance with the at least one operational parameter and in accordance with modified multi-casting including supporting bi-directional communications with the at least one additional designated wireless communication device.

23. The method of claim 16, further comprising:
identifying a plurality of groups among the plurality of wireless communication devices;
delivering media supporting the media communications with a first of the plurality of groups in accordance with a first signal quality and resolution; and
delivering media supporting at least one additional media communications with a second of the plurality of groups in accordance with a second signal quality and resolution.

24. The method of claim 16, wherein:
the first wireless communication device being an access point (AP); and
the plurality of wireless communication devices being a plurality of wireless stations (STAs).
